(19) United States
(12) Patent Application Publication
(10) Pub. No.: US 2005/0190910 A1
(43) Pub. Date: Sep. 1, 2005

(54) System for receiving inquiry by speech

(76) Inventors: Hidetada Tanaka, Yokohama (JP); Yasuyuki Sajikawa, Yokohama (JP); Hiroyuki Kadosono, Yokohama (JP); Kensuke Kubo, Yokohama (JP); Akira Hashimoto, Yokohama (JP); Chigusa Miyahara, Yokohama (JP); Kenji Takada, Yokohama (JP)

Correspondence Address: KATTEN MUCHIN ROSENMAN LLP, 575 MADISON AVENUE, NEW YORK, NY, 10022-2585, US

(21) Appl. No.: 11/115,825

(22) Filed: Apr. 27, 2005

Related U.S. Application Data
(63) Continuation of application No. PCT/JP03/01986, filed on Feb. 24, 2003.

(51) Int. Cl. G10L 15/00

(52) U.S. Cl. 379/901

(57) ABSTRACT

A system for receiving inquiry by speech includes a plurality of receiving board apparatus capable of receiving an inquiry by speech from an inquirer, a VoIP gateway apparatus connected via the LAN to a plurality of receiving apparatuses for transmitting/receiving via the LAN to/from the receiving board apparatus a speech packet containing speech data relating to communication between the recipient of the receiving board apparatus which has answered to an inquiry and inquirer, and a speech multiplexing HUB apparatus for receiving speech data input to each receiving board apparatus, time-division multiplexing them, and distributing them in parallel to each receiving board apparatus.

### BACKGROUND OF THE INVENTION

1. Field of the Invention

The present invention relates to a system for receiving an inquiry by a speech.

2. Description of the related art

Examples of a system for receiving an inquiry by a speech include an informing system to a fire station (telephone number: 119) or a police station (telephone number: 110), a call center for receiving inquiries from various inquirers, and a local government network system for receiving inquiries from residents or the like.

A message receiving system for the fire station or the police station is configured, for example, as shown in FIG. 10. That is, an emergency message receiving trunk connected to a carrier network (telephone network) and an exchange connected thereto are installed, and a plurality of receiving boards are connected to the exchange. When a message comes in from a communicant through a telephone, an incoming call from the communicant is notified to each receiving board via the exchange. When anyone of the receiving boards responds to the message, telephone calling (speech communication) is carried out between this receiving board and the communicant. Each receiving board can monitor or interrupt telephone calling at the other receiving boards.

A command center is connected to a branch office via two private lines. One private line is connected to the exchange, and is used as a speech line for transmitting a speech (command speech from the receiving board) or the like from the command center to the branch office. The other private line is connected to a LAN (Local Area Network) accommodating the receiving boards of the command center via a router, and is used as a data line for transmitting information relating to data such as sent-out vehicle data or data of a disaster site to the branch office.

In the system shown in FIG. 10, to allow each receiving board to monitor or interrupt speeches at the other receiving boards, calling speeches (speeches of a communicant and a recipient) or interruption speeches must be transferred to the other receiving boards. Such monitoring and interrupting functions are all realized by the exchange.

In a system similar to that shown in FIG. 10, speech transfer processing is performed by an exchange. Accordingly, no speech delays occur, and quality is high. However, there is a disadvantage in that a large installation space is necessary because the exchange (including a connection terminal to a MDF (Main Distribution Frame)) is large. Additionally, as a command line connected from a command center to each branch office, two lines, i.e., a data line and a speech line, are used as private lines. Thus, communication costs (line use fees) are high. Expansion such as addition of new branch offices is difficult.

In view of the aforementioned problems, use of an IP (Internet Protocol) and a LAN in place of the exchange system has been considered. FIG. 11 is a diagram showing an example in which an IP system is applied to a receiving system in place of the exchange system.

The receiving system shown in FIG. 11 includes, in place of the emergency message receiving trunk, the exchange, and the receiving boards shown in FIG. 10, a VoIP (Voice over IP) gateway apparatus connected to a carrier telephone network and a receiving board PC (Personal Computer) prepared for each receiving board and connected to the VoIP gateway via a LAN.

In each receiving board of FIG. 11, as in the case of the system shown in FIG. 10, functions of message receiving (responding), speech monitoring, interrupting, and the like can be realized. Transmission of speeches (telephone calling speech, monitoring speech, and interrupting speech) necessary for realizing the functions is realized by using a VoIP technology and transferring speech packets via the LAN.

Thus, data and speeches can both be communicated between the receiving boards by using the LAN. Moreover, a speech is treated as IP data by the VoIP technology. Accordingly, by interconnecting a command center and a branch office via one private line in which the data and the speech VoIP are integrated, the data and the speech can both be transmitted/received between the command center and the branch office.

According to the system shown in FIG. 11, the number of command lines for interconnecting the command center and the branch office is one. Thus, communication costs (line use fees) can be reduced. The PC is used as an operation terminal for each receiving board. Thus, in the middle of a progress of a highly-networked information society, high-level application services can be easily realized, and functions can be easily expanded by expansion cards or the like. Additionally, compared with the system using the exchange, constituting equipment of the system is small. Accordingly, only a small installation space is necessary. Moreover, a connection between apparatus becomes a connection between modular connectors. Thus, an installation space of a MDF is unnecessary.

It is to be noted that as a prior art concerning the present invention, for example, there is a telephone line system disclosed in Patent Document 1.

Patent Document 1

JP 2000-69512 A

In the system using the exchange shown in FIG. 10, costs are high because of the installation of the exchange. A large installation space is also necessary. Communication costs of the lines for interconnecting the command center and the branch office are high.

On the other hand, in the system configuration similar to that shown in FIG. 11, the following problems are inherent. First, in the system shown in FIG. 11, communications (both of data and speeches) between the receiving boards of the command center are all performed via the LAN. For example, when telephone calling (speech communication) at the other receiving board is monitored by a certain receiving board, a speech packet containing a calling speech is generated by the PC of the other receiving board, and is transferred to the PC of the receiving board which executes the monitoring via the LAN. When the other receiving board interrupts telephone calling at a certain receiving board, a speech packet containing an interrupting speech is transferred to the PC of the receiving board of the interrupted side. Accordingly, in the system shown in FIG. 11, many speech packets are transmitted via the LAN of the command center. Thus, an amount of traffic via the LAN becomes large to cause congestion, creating a possibility of inviting packet delays. Importance is placed on quality for speech communication. Thus, such a possibility must be prevented.

Second, in the VoIP technology, to generate a speech packet, compression encryption and packet creation (generation of speech packet) of speech data are essential. Accordingly, a delay or a fluctuation (jitter) occurs in speech transfer. Thus, in the case of monitoring a speech of an adjacent receiving board by a certain receiving board, when an operator's voice is issued at the adjacent receiving board, there is a possibility that a phenomenon of delayed output of the operator's voice (speech transferred from the adjacent receiving board via the LAN) occurs at the receiving board. In this case, since the same voice is heard by the monitoring operator with time shifted, there is a possibility that contents may not be accurately heard. At the command center of the fire or police station, contents of telephone calling require immediate attention in many cases. Thus, it is necessary to prevent the occurrence of the phenomenon.

### SUMMARY OF THE INVENTION

An object of the present invention is to provide a system for receiving an inquiry by a speech, capable of preventing a speech delay.

Another object of the present invention is to provide a receiving system capable of suppressing the occurrence of congestion of a LAN for interconnecting receiving board apparatus.

Yet another object of the present invention is to provide a receiving system which enables monitoring or interruption of telephone calling therein from a remote place.

The present invention employs the following configuration to achieve the objects described above.

That is, the present invention provides a system for receiving an inquiry by a speech, which includes:
a plurality of receiving board apparatus for receiving an inquiry by a speech from an inquirer;
a VoIP gateway apparatus connected to the plurality of receiving board apparatus via a LAN to transmit/receive a speech packet containing speech data regarding telephone calling between a recipient of a receiving board apparatus which responds to the inquiry and the inquirer to/from the receiving board apparatus; and
a speech multiplexing HUB apparatus for receiving speech data input to each receiving board apparatus therefrom, time-division multiplexing the speech data, and distributing the speech data in parallel to the respective receiving board apparatus.

According to the present invention, the speech data input to the receiving board apparatus is distributed to the other receiving board apparatus not via the LAN but via the speech multiplexing HUB apparatus. Thus, the data amount of packets transmitted through the LAN can be limited. The speech data input to each receiving board apparatus is time-division multiplexed without being formed into a packet, and is distributed to the other receiving board apparatus. As a result, a speech delay can be suppressed.

The following configuration can be applied to the present invention, in which:
each receiving board apparatus includes a control unit, a speech mixing/distribution apparatus, a speech output unit, and a speech input unit;
the control unit supplies the speech of the inquirer contained in the speech packet received from the VoIP gateway apparatus to the speech mixing/distribution apparatus, generates a speech packet containing the speech received from the speech mixing/distribution apparatus as a speech to be sent to the inquirer, and transmits the speech packet to the VoIP gateway apparatus; and
the speech mixing/distribution apparatus includes:
   a received speech selection unit for selecting at least one of speech data regarding the speech of the inquirer and speech data of the other receiving board apparatus input from the speech multiplexing HUB apparatus as a speech to be output from the speech output unit, and outputting the speech data;
   a transmitted speech selection unit for selecting at least one of speech data of the recipient input from the speech input unit and the speech data of the other receiving board apparatus input from the speech multiplexing HUB apparatus as a speech to be transmitted to the inquirer, and outputting the speech data; and
   a transferred speech selection unit for selecting at least one of the speech data regarding the speech of the inquirer and the speech data of the recipient input from the speech input unit as a speech to be sent to the speech multiplexing HUB apparatus, and outputting the speech data.

With the configuration, each receiving board apparatus can send any speech data to the speech multiplexing HUB apparatus. Additionally, each receiving board apparatus can select a desired speech from speeches of the plurality of receiving board apparatus received via the speech multiplexing HUB apparatus and output it.

The following configuration can be applied to the present invention, in which the control unit of each receiving board apparatus controls the selection and outputting processing of the speech data of the received speech selection unit, the transmitted speech selection unit, and the transferred speech selection unit.

The following configuration can be applied to the present invention, in which when a response instruction to an incoming call from the inquirer is input, the control unit of each receiving board apparatus controls the transferred speech selection unit to select the speech data regarding the speech of the inquirer and the speech data of the recipient input from the speech input unit and to output the speech data to the speech multiplexing HUB apparatus.

Thus, at each receiving board apparatus, by taking an opportunity of a response to the incoming call from the inquirer, the transferred speech selection unit can send a speech concerning telephone calling (conversation) between the inquirer and the recipient to the speech multiplexing HUB apparatus, thereby transferring the speech to the other receiving board apparatus.

The following configuration can be applied to the present invention, in which when a monitoring instruction of a speech input to the other receiving board apparatus is input, the control unit of each receiving board apparatus controls the received speech selection unit to select the speech data of the other receiving board apparatus received from the speech multiplexing HUB apparatus and to output the speech data.

Thus, by taking an opportunity of the monitoring instruction, each receiving board apparatus can select and output a speech for monitoring the other receiving board apparatus by the received speech selection unit, thereby outputting it from the speech output unit.

The following configuration can be applied to the present invention, in which:
when an interruption instruction to one side of telephone calling at the other receiving board apparatus is input, the control unit of each receiving board apparatus transmits a packet containing control data regarding the interruption to the control unit of the other receiving board apparatus via the LAN; and
based on the control data contained in the packet, the control unit of the other receiving board apparatus controls the received speech selection unit of the other receiving board apparatus to select the speech data regarding the speech of the inquirer and the speech data of the interrupting receiving board apparatus received from the speech multiplexing HUB apparatus and to output the speech data.

With the configuration, each receiving board apparatus can transmit the control data regarding the interruption to the other receiving board apparatus via the LAN. Moreover, each receiving board apparatus can select and output the interruption speech by the received speech selection unit based on the control data regarding the interruption, thereby outputting it from the speech output unit.

The following configuration can be applied to the present invention, in which:
when an interruption instruction to both sides of telephone calling at the other receiving board apparatus is input, the control unit of each receiving board apparatus transmits a packet containing control data regarding the interruption to the control unit of the other receiving board apparatus via the LAN; and
based on the control data contained in the packet, the control unit of the other receiving board apparatus controls the received speech selection unit of the other receiving board apparatus to select the speech data regarding the speech of the inquirer and the speech data of the interrupting receiving board apparatus received from the speech multiplexing HUB apparatus and to output the speech data, and the transmitted speech selection unit of the other receiving board apparatus to select the speech data input from the speech input unit and the speech data of the interrupting receiving board apparatus received from the speech multiplexing HUB apparatus and to control the speech data.

With the configuration, each receiving board apparatus can transmit the control data regarding the interruption to the other receiving board apparatus via the LAN. Moreover, each receiving board apparatus can select and output the interruption speech by the received speech selection unit based on the control data regarding the interruption, thereby outputting it from the speech output unit and transmitting it to the inquirer.

The following configuration can be applied to the present invention, in which:
the LAN is connected to a second LAN accommodating at least one second receiving board apparatus similar in configuration to the receiving board apparatus via a data line capable of transmitting packets;
the second receiving board apparatus receives data of the time-division multiplexed speech data of each receiving board apparatus transmitted from the speech multiplexing HUB apparatus via an analog line;
when an assistance request is input, the control unit of each receiving board apparatus transmits a packet containing data regarding the assistance request to the control unit of the second receiving board apparatus via the data line; and
when a response instruction to the assistance request is input, the control unit of the second receiving board apparatus controls the received speech selection means of the second receiving board apparatus to select speech data of an assistance request source receiving board apparatus from the time-division multiplexed data and to output the speech data.

With the configuration, even when the second receiving board apparatus is installed in a place remote from the receiving board apparatus, it can receive the speech of each receiving board apparatus, thereby executing monitoring. Moreover, the speech of each receiving board apparatus is transmitted to the second receiving board apparatus via the analog line. Thus, an increase in the packet data amount of the LAN is suppressed.

The following configuration can be applied to the present invention, in which:
when an interruption instruction to one side of telephone calling at the assisted receiving board apparatus is input, the control unit of the second receiving board apparatus transmits a packet containing control data regarding the interruption to the control unit of the assisted receiving board apparatus via the data line;
the speech mixing/distribution apparatus of the second receiving board apparatus outputs speech data of an interruption speech input to itself, the speech data of the interruption speech is input to the speech multiplexing HUB apparatus via the analog line, and the speech multiplexing HUB apparatus inputs the speech data of the interruption speech to the assisted receiving board apparatus; and
based on the control data contained in the packet, the control unit of the assisted receiving board apparatus controls the received speech selection unit of the assisted receiving board apparatus to select the speech data regarding the speech of the inquirer and the speech data of the interruption speech received from the speech multiplexing HUB apparatus and to output the speech data.

With the configuration, the control data regarding the interruption can be transmitted to the assisted receiving board apparatus via the data line. Additionally, the interruption speech can be transferred to the assisted receiving board apparatus via the analog line.

The following configuration can be applied to the present invention, in which:
when an interruption instruction to both sides of telephone calling at the assisted receiving board apparatus is input, the control unit of the second receiving board apparatus transmits a packet containing control data regarding the interruption to the control unit of the assisted receiving board apparatus via the data line;
the speech mixing/distribution apparatus of the second receiving board apparatus outputs speech data of an interruption speech input to itself, the speech data of the interruption speech is input to the speech multiplexing HUB apparatus via the analog line, and the speech multiplexing HUB apparatus inputs the speech data of the interruption speech to the assisted receiving board apparatus; and
based on the control data contained in the packet, the control unit of the assisted receiving board apparatus controls the received speech selection unit of the assisted receiving board apparatus to select the speech data regarding the speech of the inquirer and the speech data of the interruption speech received from the speech multiplexing HUB apparatus and to output the speech data, and the transmitted speech selection unit of the assisted receiving board apparatus to select the speech data input from the speech input unit and the speech data of the interruption speech received from the speech multiplexing HUB apparatus and to output the speech data.

With the configuration, the control data regarding the interruption can be transmitted to the assisted receiving board apparatus via the data line. Additionally, the interruption speech can be transferred to the assisted receiving board apparatus via the analog line. The interruption speech can be transmitted to both of the inquirer and the recipient.

The following configuration can be applied to the present invention, in which:
the LAN is connected to a second LAN accommodating at least one second receiving board apparatus similar in configuration to the receiving board apparatus via a data line capable of transmitting packets;
when an assistance request is input, the control unit of each receiving board apparatus transmits a packet containing data regarding the assistance request to the control unit of the second receiving board apparatus via the data line, and transfers a speech packet containing a monitoring target speech to the second receiving board apparatus which responds to the assistance request; and
when a response is made to the assistance request, the second receiving board apparatus outputs the monitoring target speech contained in the speech packet received from the assistance request source receiving board apparatus from the speech output unit included in the second receiving board apparatus.

With the configuration, even when the second receiving board apparatus is installed in a place remote from the receiving board apparatus, it can receive the speech of each receiving board apparatus, thereby executing monitoring. Moreover, the monitoring speech is transferred to the second receiving board apparatus by using the data line including the LAN. Thus, the line for interconnecting each receiving board apparatus and the second receiving board apparatus can be constituted of only the data line including the LAN (it is not necessary to prepare another speech line).

The following configuration can be applied to the present invention, in which:
when an interruption instruction to one side of telephone calling at the assisted receiving board apparatus is input, the second receiving board apparatus transmits a packet containing control data regarding the interruption to the control unit of the assisted receiving board apparatus via the data line, and the speech packet containing the interruption speech input from the speech input unit included in the second receiving board apparatus to the control unit of the assisted receiving board apparatus via the data line; and
the assisted receiving board apparatus outputs the interruption speech contained in the speech packet from the speech output unit based on the control data regarding the interruption.

The following configuration can be applied to the present invention, in which:
when an interruption instruction to both sides of telephone calling at the assisted receiving board apparatus is input, the second receiving board apparatus transmits a packet containing control data regarding the interruption to the control unit of the assisted receiving board apparatus via the data line, and a speech packet containing an interruption speech input from the speech input unit included in the second receiving board apparatus to the assisted receiving board apparatus via the data line; and
the assisted receiving board apparatus outputs the interruption speech contained in the speech packet from the speech output unit and transmits the interruption speech to the inquirer based on the control data regarding the interruption.

The following configuration can be applied to the present invention, in which:
the speech mixing/distribution apparatus of the assisted receiving board apparatus further includes second transmitted speech selection unit capable of selecting speech data regarding a speech of the inquirer and speech data of the recipient and outputting the speech data; and
when the control unit of the assisted receiving board apparatus receives a response to the assistance request from the second receiving board apparatus, it controls the second transmitted speech selection unit to select the speech data of the inquirer and the speech data of the recipient and to output the speech data, and generates a speech packet containing the speech of the inquirer and/or the speech of the recipient received from the speech mixing/distribution apparatus and transmits the speech packet to the second receiving board apparatus.

The following configuration can be applied to the present invention, in which:
the speech mixing/distribution apparatus of the assisted receiving board apparatus further includes second received speech selection unit capable of selecting and outputting the speech data of the interruption speech when the speech data of the interruption speech contained in the speech packet from the second receiving board apparatus is input; and
when the control unit of the assisted receiving board apparatus receives the packet containing the control data regarding the interruption, it controls the second received speech selection unit to select the speech data of the interruption speech and to transmit the speech data to the speech output unit based on the control data regarding the interruption.

The following configuration can be applied to the present invention, in which:
the speech mixing/distribution apparatus of the assisted receiving board apparatus further includes second received speech selection unit capable of selecting and outputting the speech data of the interruption speech when the speech data of the interruption speech contained in the speech packet from the second receiving board apparatus is input; and
when the control unit of the assisted receiving board apparatus receives the packet containing the control data regarding the interruption, it controls the second received speech selection unit to select the speech data of the interruption speech and to output the speech data to the speech output unit and the transmitted speech selection unit to select and output the speech data of the interruption speech input to itself based on the control data regarding the interruption.

### BRIEF DESCRIPTION OF THE DRAWINGS

FIG. 1 is a diagram showing a configuration example of a receiving system according to Embodiment 1 of the present invention.

FIG. 2 is a diagram showing a configuration example of a receiving board apparatus shown in FIG. 1.

FIG. 3 is a diagram showing a display example of an LCD (receiving operation unit) of the receiving board apparatus shown in FIG. 1.

FIG. 4 is a function explanatory diagram (timing chart) of a speech multiplexing HUB apparatus shown in FIG. 1.

FIGS. 5A to 5E are explanatory diagrams showing examples of a mixing control system of a speech mixing/distribution apparatus shown in FIG. 1.

FIG. 6 is a view showing a system configuration example according to Embodiment 2.

FIG. 7 is a diagram showing a configuration example of a speech multiplexing HUB apparatus of Embodiment 2.

FIG. 8 is a diagram showing a system configuration example according to Embodiment 3.

FIG. 9 is a diagram showing a configuration example of a receiving board apparatus of Embodiment 3.

FIG. 10 is an explanatory diagram of a prior art.

FIG. 11 is an explanatory diagram of a prior art.

### BEST MODE FOR CARRYING OUT THE INVENTION

Hereinafter, the best mode for carrying out the present invention will be described with reference to the accompanying drawings. Configurations of the embodiments are only illustrative, and not limitative of the present invention.

[Overview]

To solve the conventional problems, the embodiments of the present invention add the following schemes.

(1) Addition of a scheme which transmits/receives a speech of telephone calling monitoring or interruption at an adjacent another receiving board not via a LAN (VoIP) but through TDM processing of no speech delays.

(2) Addition of a scheme which can freely synthesize (mix/distribute) speeches of VoIP data and time-division multiplexed (TDM: Time Division Multiplexing) data.

(3) Addition of a scheme which multiplexes speech data (containing telephone calling contents) of all the receiving boards, and outputs the multiplexed TDM data in parallel to all the receiving boards.

(4) Addition of a scheme which performs communication via a LAN to enable rendering of high-level application services (incoming call/responding/redialing/transferring/holding/telephone call recording and reproducing) for a telephone call speech (VoIP) and control data (data of TDM mixing point setting and call connection of carrier network) via a telephone station (carrier).

(5) Realization of the schemes by a PC and a LAN for a speech mixing/distribution apparatus and a speech multiplexing HUB (TDM) apparatus and a receiving board (or “command board”), and by simplifying a system configuration.

### Embodiment 1

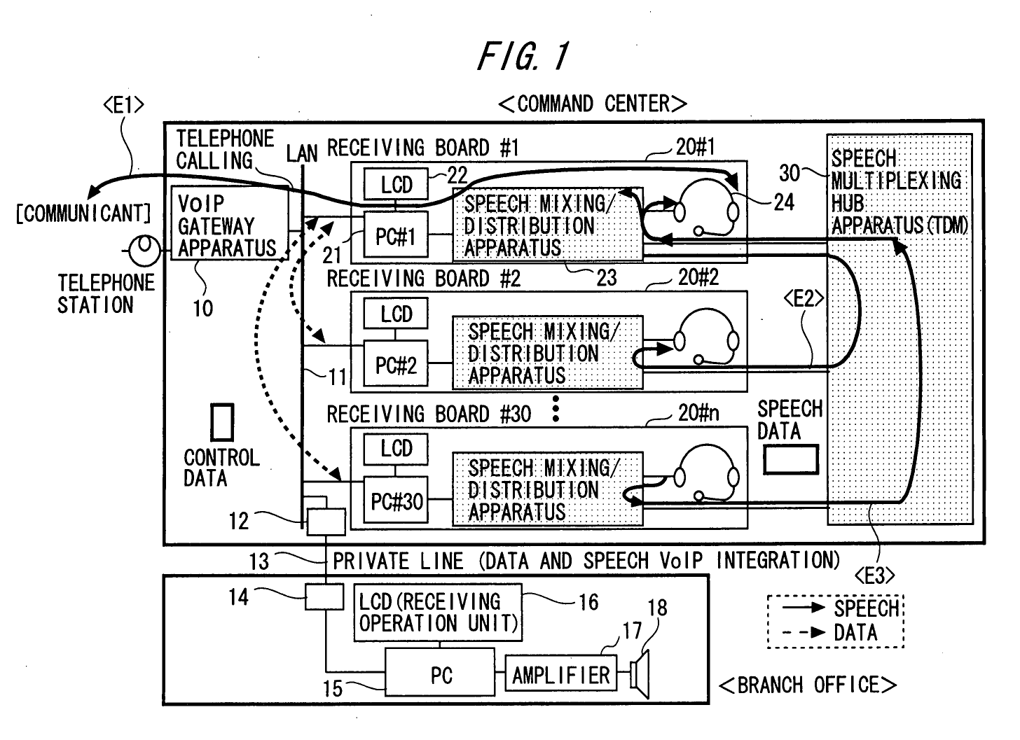

FIG. 1 is a diagram showing a configuration example of a receiving system according to Embodiment 1. FIG. 1 shows the receiving system installed in a command center for receiving an emergency message to a fire station, a police station, or the like from the outside via a telephone network (carrier network).

The command center includes a plurality (n) of receiving boards ((n is an integer of 1 or higher): n=30 (#1 to #30) in FIG. 1) for receiving speech messages from communicants which are transmitted via the carrier network. An operator of each receiving board can receive (respond to) a message from the communicant as a recipient. The operator of each receiving board can monitor or interrupt telephone calling at the other receiving board. The interruption is classified into “operator interruption (recipient interruption) in which an operator of a certain receiving board interrupts only the recipient side for telephone calling between the communicant and the recipient at the other receiving board, and “both side interruption” in which the operator interrupts both of the communicant and the recipient. Moreover, the operator of each receiving board can report an instruction or the like based on telephone calling to a branch office connected the command center via a data line.

The branch office includes a router 14 connected to a router 12 connected to a LAN 11 of a command center via a private line (integration of data and speech VoIP) 13, a branch office PC 15 connected to the router 14, an LCD (receiving operation unit) 16 connected to the branch office PC 15, an amplifier 17 connected to the branch office PC 15, and a speaker 18 connected to the amplifier 17. With such a configuration, at the branch office, the PC 15 receives a speech packet containing an instruction speech from the command center via the router 14, and the speech contained in the speech packet is amplified by the amplifier 17 and output from the speaker 18. Thus, a worker of the branch office can listen to the instruction from the command center.

A receiving system at the command center includes a VoIP gateway apparatus (or “VoIP-GW”) 10 connected to the carrier telephone network, receiving board apparatus 20 (20#1 to 20#n) prepared for receiving boards, and a speech multiplexing HUB apparatus (TDM) 30.

The receiving board apparatus 20 have configurations similar to one another. Each receiving board apparatus 20 includes a receiving board computer (receiving board PC) 21 (referred to as “PC 21”, hereinafter) as a control unit connected to the VoIP gateway apparatus 10, a liquid crystal display (LCD) 22 connected to the PC 21 to function as a receiving operation unit, a speech mixing/distribution apparatus 23 connected to the PC 21 and the speech multiplexing HUB apparatus 30, and a breast (headset) 24 connected to the speech mixing/distribution apparatus 23.

The breast 24 is a transmitter/receiver which a recipient (operator of receiving board) fixes to a head to hold a conversation with a communicant (inquirer) or the like. The breast 24 has a speech reception unit (speaker: speech output unit) 24A arranged in an ear part, and a speech transmission unit (microphone: speech input unit) 24B arranged in a mouth part.

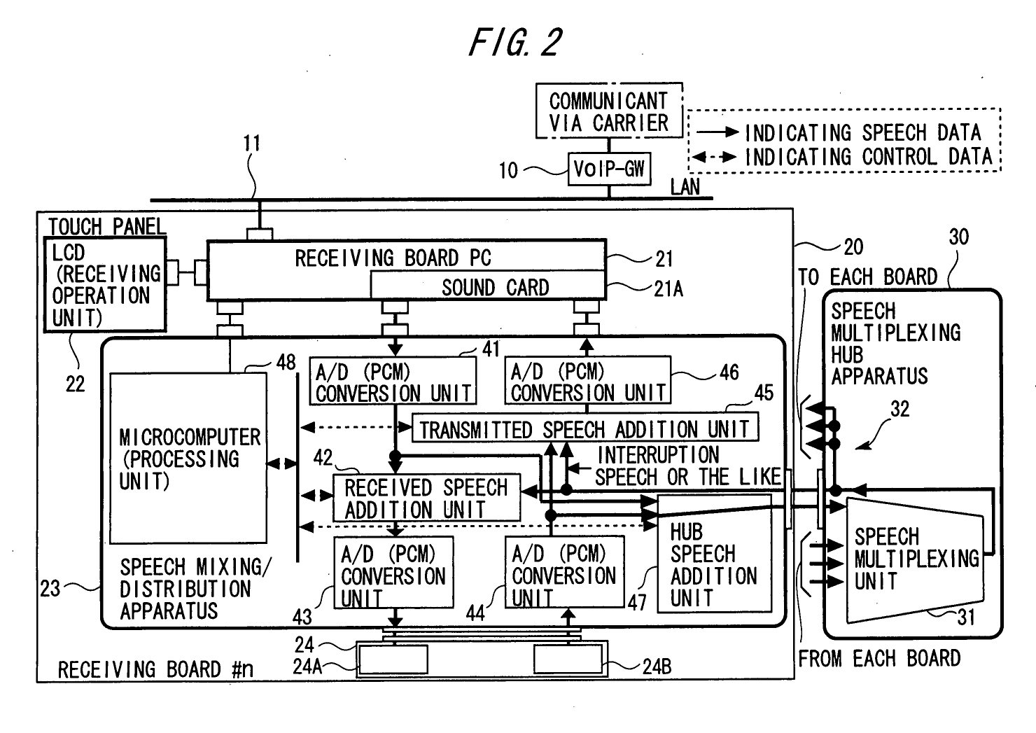

The speech mixing/distribution apparatus 23 mixes and distributes a speech from the breast 24 (speech of recipient or the like), a speech from the speech multiplexing HUB apparatus 30 (speech from the other receiving board), and a speech from the PC 21 (speech of communicant) based on control information from the PC 21. That is, the speech mixing/distribution apparatus 23 outputs the speech of the communicant (VoIP-GW 10) to the recipient. At this time, the speech of the communicant is transmitted by a route of a sound card (incorporated in PC 21: FIG. 2)→the speech mixing/distribution apparatus 23→the breast 24. Additionally, the speech mixing/distribution apparatus 23 outputs the speech of the recipient to the communicant. At this time, the speech of the recipient is transmitted by a route of the breast 24→the speech mixing/distribution apparatus 23→the sound card incorporated in the receiving board PC→the VoIP gateway apparatus 10.

The speech multiplexing HUB apparatus 30 receives speech data from the speech mixing/distribution apparatus 23 of each receiving board, and time-division multiplexes (TDM) the speech data of all the receiving boards by time slots (e.g., 1 ch (channel) is prepared for each receiving board) whose prepared number is at least n (for all the receiving boards). The speech multiplexing HUB apparatus 30 outputs the time-division multiplexed speech data in parallel to the speech mixing/distribution apparatus 23 of all the receiving boards.

The PC 21 and the LCD 22 control a telephone calling speech communicated with the VoIP (between communicant and recipient), and addition speech data for speech addition at the speech mixing/distribution apparatus 23. The PC 21 and the LCD 22 have functions of calling 119 (fire station) or 110 (police station), responding, redialing, and disconnecting controlled for communication by TCP/IP, and a function of controlling notification of button operation information and button displaying.

The VoIP gateway apparatus 10 interconnects the carrier network (telephone network) and an interface device of the receiving board PC 21, detects a call incoming to an emergency information line (119/110 or the like) of the carrier network, and notifies all the PC's 21 through the LAN 11. The VoIP gateway apparatus 10 has a redialing function of each receiving board (function of executing ringer dialing from the receiving board when a carrier subscriber (communicant) disconnects the line)/function of sending a redialing/disconnecting signal to the carrier emergency information line by a recovery operation. The VoIP gateway apparatus 10 further has a function of receiving a speech signal or speech data regarding a speech from the communicant, generating a speech packet containing the speech, and transferring the speech packet to a specific receiving board via the LAN 11, and a function of converting the speech packet received from the LAN 11 into speech data or a speech signal and sending it to the communicant.

### DETAILED CONFIGURATION

FIG. 2 is a diagram showing a detailed configuration example of the receiving board apparatus 20 shown in FIG. 1. As shown in FIG. 2, the PC 21 includes a LAN interface for accommodating the LAN 11 to which the VoIP gateway apparatus 10 is connected, and an interface for connection to the LCD 22.

The PC 21 includes a processor such as a CPU, a main memory, and an auxiliary memory, which are not shown. The processor executes various programs stored in the auxiliary memory, thereby realizing functions of controlling a call from the communicant via the VoIP-GW 10 and transmitting/receiving a speech packet to/from the VoIP-GW 10 via the LAN.

The PC 21 includes a sound card 21A for converting the speech data contained in the speech packet from the LAN 11 into a speech signal (analog) and outputting the signal, or converting a speech signal (analog) input from the outside into speech data. Accordingly, the PC 21 functions as a VoIP terminal (IP telephone terminal).

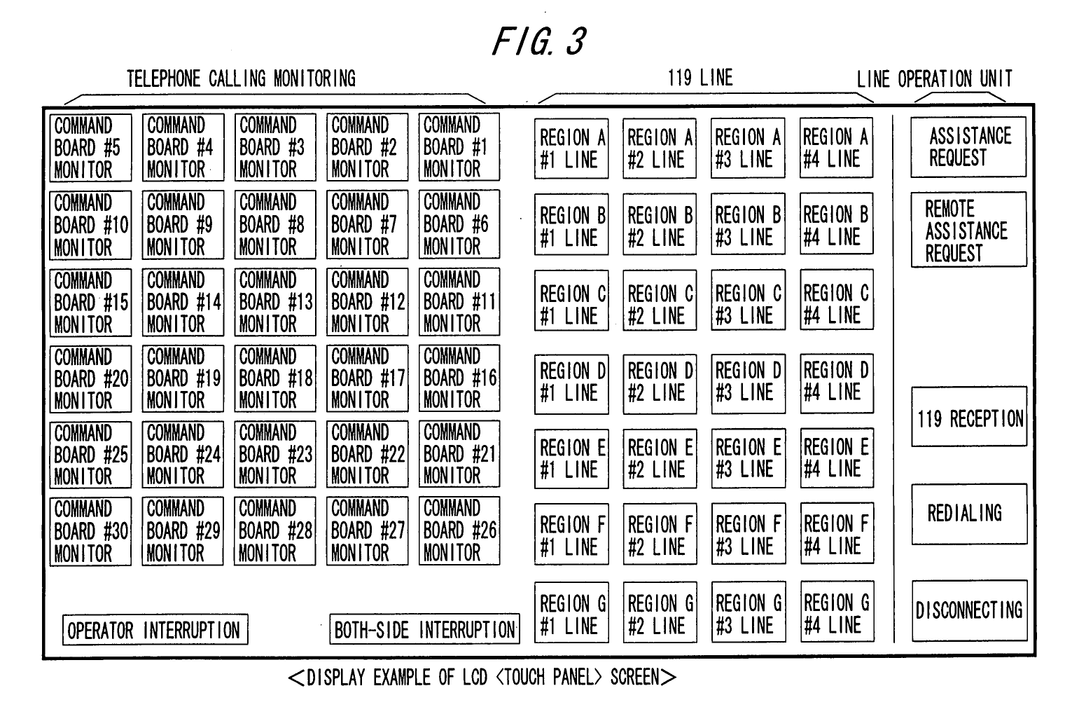

The LCD 22 is constituted as a touch panel having a plurality of buttons, realizing a user interface similar to that shown in FIG. 3 to realize functions of call control, telephone calling monitoring, interruption, and the like.

In a display example shown in FIG. 3, the LCD 22 includes, as the user interface, a monitor button prepared for each receiving board (command board), an “operator interruption” button, a “both-side interruption” button, and a plurality of line buttons for an emergency number (“119” in this example). The LCD 22 includes, as a line operation unit, an “assistance request” button, a “remote assistance request” button, a “119 number receiving” button, a “redialing” button, and a “disconnecting” button. Each button is constituted to display a state regarding the function allocated thereto by lighting, flashing, switching-off of light, a display color, or the like. The functions of the buttons are as follows.

Each monitor button constitutes a button group for performing a monitoring operation of telephone calling at the other receiving board. Each monitor button indicates an “unused” (not monitored) state in a light-out state. Flashing (120 INT) indicates that a receiving board corresponding to the button requests assistance (“assistance being requested”). When the button is pressed during the flashing, a continuous lighting state indicating “monitoring” is set. When the button is pressed in the continuous lighting state, a “monitor released (unused)” state is set to return to the light-out state.

The operator interruption button is for interrupting the recipient side of the telephone calling at the other receiving board. The operator interruption button indicates “unused” in the light-out state. When the button is pressed during the “monitoring”, the state changes to a continuous lighting state. This continuous lighting state indicates “operator interrupting”. When the button is pressed during the “operator interrupting”, “operator interruption released” is set to change to a light-out state.

The both-side interruption button is for interrupting both sides of the telephone calling at the other receiving board. The both-side interruption button indicates “unused” in the light-out state. When the button is pressed during the “monitoring”, the state changes to a continuous lighting state. This continuous lighting state indicates “both-side interrupting”. When the button is pressed during the “both-side interrupting”, “both-side interruption released” is set to change to a light-out state.

Each line button is for performing an operation for an incoming call of an emergency message (119) to a plurality (m) of lines (m is an integer of 1 or higher: m=1 to 4 in this example) prepared for each region y (y=A to G in this example). The button indicates “free (no incoming call)” in the light-out state. The red flashing of the button indicates a state in which a message comes into a line corresponding to the button (“call incoming to 119”). When the red-flashing button or the 119 receiving button is pressed, a response is made to the call, setting a continuous red lighting state indicating “telephone calling (during speech communication)”. When the disconnecting button is pressed in the continuous red lighting state, “disconnect” is set to change to a light-out state. A state in which the button is lit by yellow indicates telephone calling at the other receiving board.

The assistance request button is used when assistance (support) is requested to the other receiving board in the command center. The light-out state indicates “unused”. When the button is pressed in the light-out state, the state changes to a lighting state. The lighting state indicates “assistance being requested”. While the assistance request button is lit at a certain receiving board, a monitor button corresponding to the receiving board is set in a flashing state at the LCD of the other receiving board. It is to be noted that when the other receiving board receives the assistance request, the light automatically goes off.

The remote assistance button is used when assistance (support) is requested to the other receiving board present in a remote place (outside the command center). The remote assistance button indicates “unused” in the light-out state. When the button is pressed in the light-out state, a lighting state is set. The lighting state indicates “assistance being requested”. At this time, at the LCD of the other receiving board of the assistance requested side (described later) present in the remote place, a monitor button corresponding to the receiving board is set in a flashing state. It is to be noted that when the other receiving board receives the assistance request, the light automatically goes off.

The 119 receiving button is for responding to (receiving) an incoming call of a message. The light-out state indicates “unused”. The flashing state (120 INT) indicates a message incoming to a line corresponding to the flashing line button. The lighting state indicates “telephone calling”. It is to be noted that when the disconnecting button is pressed in the lighting state, the state changes to a light-out state.

The redialing button is used when the recipient calls the communicant. The redialing button indicates “unused” in the light-out state. When the button is pressed in the case of disconnecting the telephone calling before the communicant, transmission is made to the communicant to call the same. The redialing button is lit only during pressing, and is switched off when the pressing is stopped.

The disconnecting button is used for disconnecting telephone calling. When the disconnecting button is pressed during “telephone calling”, the telephone calling with the communicant is disconnected from the recipient side.

It is to be noted that each of various existing configurations can be applied for an apparatus configuration to operate the receiving board apparatus.

The PC 21 (processor thereof) is connected to a microcomputer (processing unit: control unit) 48 of the speech mixing/distribution apparatus 23 via the interface. The input and output units of the speech signal of the sound card 21A are connected to the speech mixing/distribution apparatus 23 via the interface.

The speech mixing/distribution apparatus 23 includes an A/D conversion unit (PCM codec) 41 connected to the speech output unit of the sound card 21A via the interface, a received speech addition unit 42 (received speech selection unit) connected to the A/D conversion unit 41, and an A/D conversion unit (PCM codec) 43 connected to the received speech addition unit 42. The A/D conversion unit 43 is connected to a speech reception unit 24A of the breast 24 via the interface.

The A/D conversion unit 41 converts a speech signal (analog) from the sound card 21A into PCM (Pulse Code Modulation) data (or “speech data”). The received speech addition unit 42 performs addition processing (selection and outputting) for speech data input from the A/D conversion unit 41 and speech data input from the speech multiplexing HUB apparatus 30. The A/D conversion unit 43 converts speech data from the received speech addition unit 42 into a speech signal (analog), and outputs the speech signal to the speech reception unit 24A.

With such a configuration, a speech (speech of the communicant) from the PC 21 (VoIP-GW 10) is passed through each of the units and output from the speech reception unit 24A. The speech reception unit 24A can also output a speech (monitoring or interruption speech from the other receiving board) from the speech multiplexing HUB apparatus 30 added at the received speech addition unit 42.

Additionally, the speech mixing/distribution apparatus 23 includes an A/D conversion unit (PCM codec) 44 connected to a speech transmission unit 24B of the breast 24 via the interface, a transmitted speech addition unit 45 (transmitted speech selection unit) connected to the A/D conversion unit 44, and an A/D conversion unit (PCM codec) 46 connected to the transmitted speech addition unit 45. The A/D conversion unit 46 is connected to the speech input unit of the sound card 21A via the interface.

The A/D conversion unit 44 converts a speech signal (analog) input from the speech transmission unit 24B into PCM data (speech data). The transmitted speech addition unit 45 performs addition processing (selection and outputting) for speech data input from the A/D conversion unit 44 and speech data input from the speech multiplexing HUB apparatus 30. The A/D conversion unit 46 converts PCM data from the transmitted speech addition unit 45 into a speech signal (analog), and outputs the speech signal to the speech input unit of the sound card 21A.

Thus, a speech (speech of the recipient) input from the speech transmission unit 24B is passed through each of the units and input to the sound card 21A. A speech packet containing the speech is generated at the PC 21, and is sent to the VoIP-GW 10 via the LAN 11. The VoIP-GW 10 converts the speech packet into speech data, and sends the speech data to the carrier network. Thus, the speech of the recipient is transmitted to the communicant. At this time, when the transmitted speech addition unit 45 adds a PCM signal (interruption speech from the other receiving board) from the speech multiplexing HUB apparatus 30, this interruption speech is transmitted to the communicant as in the case of the speech of the recipient.

Furthermore, the speech mixing/distribution apparatus 23 includes a HUB speech addition unit 47 (transferred speech selection unit) to which PCM signals are input from the A/D conversion units 41 and 44. The HUB speech addition unit 47 sends the PCM signals (speech data) input from the A/D conversion units 41 and 44 in an input sequence directly (continuously) to the speech multiplexing HUB apparatus 30.

The speech multiplexing HUB apparatus 30 is connected to the speech mixing/distribution apparatus 23 of each receiving board via the interface. The speech multiplexing HUB apparatus 30 includes a speech multiplexing unit 31 for receiving and time-division multiplexing speech data (PCM signal) output from each speech mixing/distribution apparatus 23, and a distribution unit 32 for distributing and sending the time-division multiplexed speech data (may be referred to as “TDM data”, hereinafter) to each speech mixing/distribution apparatus 23.

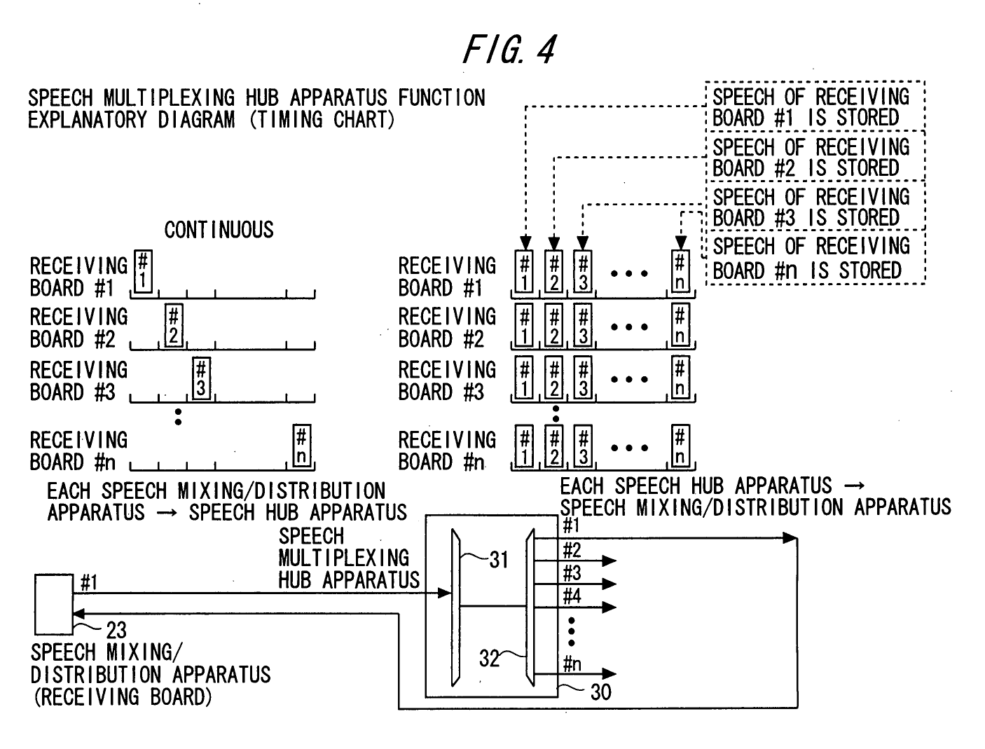

FIG. 4 is a function explanatory diagram of the speech multiplexing HUB apparatus 30. As shown in FIG. 4, the speech multiplexing HUB apparatus 30 prepares a channel (time slot (TS)) for at least each receiving board apparatus (all receiving boards) which it accommodates itself. The speech multiplexing unit 31 stores speech data input from the speech mixing/distribution apparatus 23 of each receiving board in the time slot (channel) allocated to each receiving board. Accordingly, the speech multiplexing unit 31 time-division multiplexes speech data from each receiving board. The distribution unit 32 outputs time-division multiplexed speech data (TDM data) in parallel to all the receiving boards. The TDM data (speech data of each receiving board) distributed to each receiving board is input to the received speech addition unit 42 and the transmitted speech addition unit 45 as described above. Thus, the speech multiplexing HUB apparatus 30 time-division multiplexes the speech data of all the receiving boards and outputs the speech data in parallel to the receiving board apparatus 20. Accordingly, speech data (monitoring or interruption speech data) from the other receiving board is supplied to each receiving board apparatus 20 (speech mixing/distribution apparatus 23 thereof) with almost no delays. By controlling an output with respect to the speech input from the other receiving board to the speech mixing/distribution apparatus 23, it is possible to output the monitoring or interruption speech from the breast 24 without any delays.

The microcomputer 48 of the speech mixing/distribution apparatus 23 is connected to the received speech addition unit 42, the transmitted speech addition unit 45, and the HUB speech addition unit 47 via a control bus. The microcomputer 48 controls addition processing (selection and outputting) for the speech data of the communicant at the received speech addition unit 42 and the transmitted speech addition unit 45, the speech data of the recipient, and the speech data from the speech multiplexing HUB apparatus 30 according to an instruction (control information) from the PC 21. Additionally, the microcomputer 48 controls addition processing (sending processing of speech data to the speech multiplexing HUB apparatus 30) at the HUB speech addition unit 47 according to an instruction (control information) from the PC 21.

Each receiving board PC 21 supplies control data of the speech mixing/distribution apparatus 23 generated according to operation contents of the LCD 22 to the microcomputer 48. The microcomputer 48 controls addition processing according to control information.

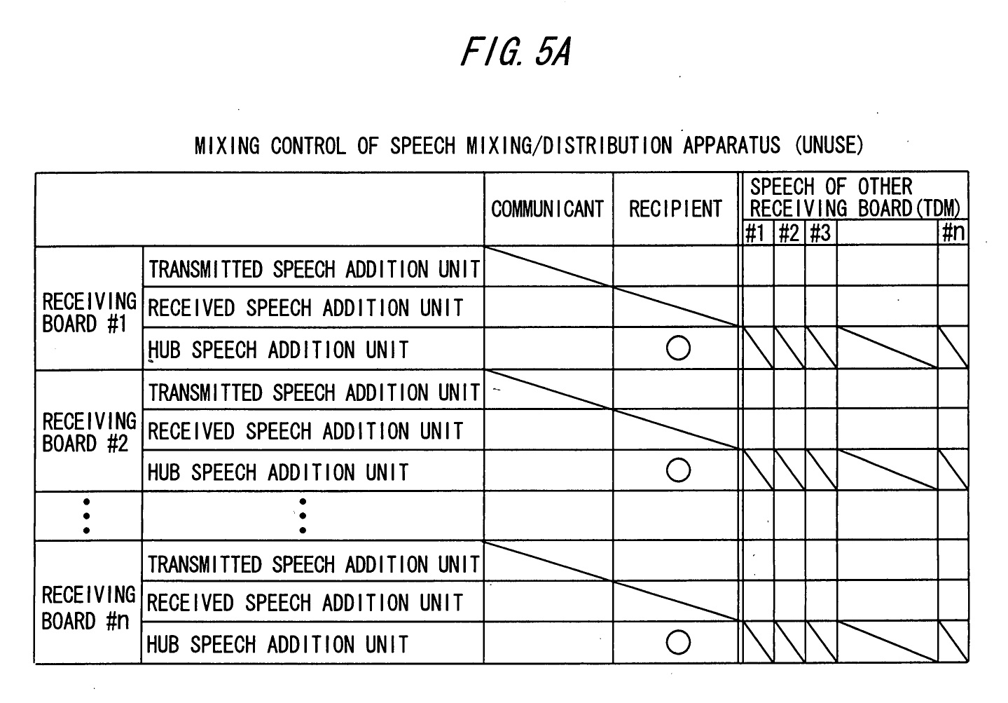

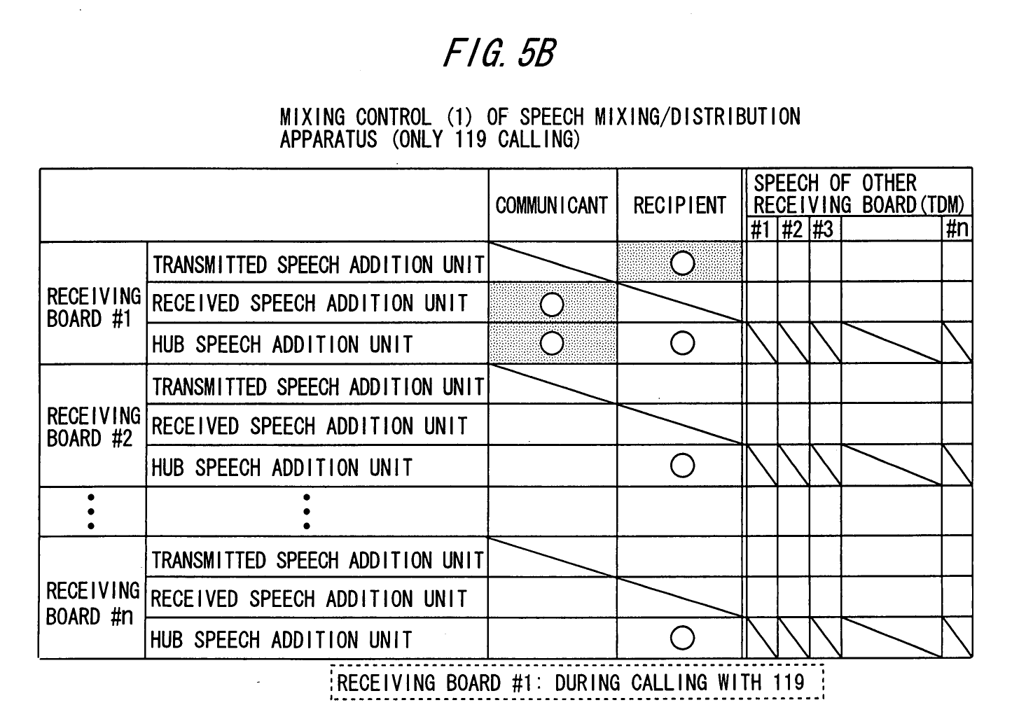

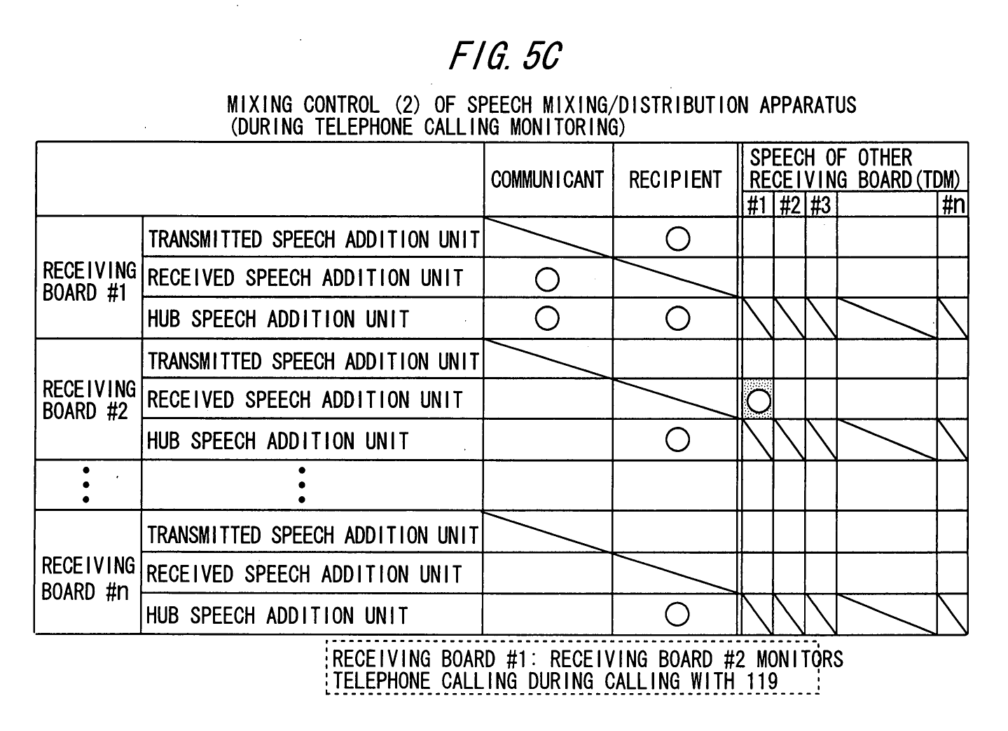

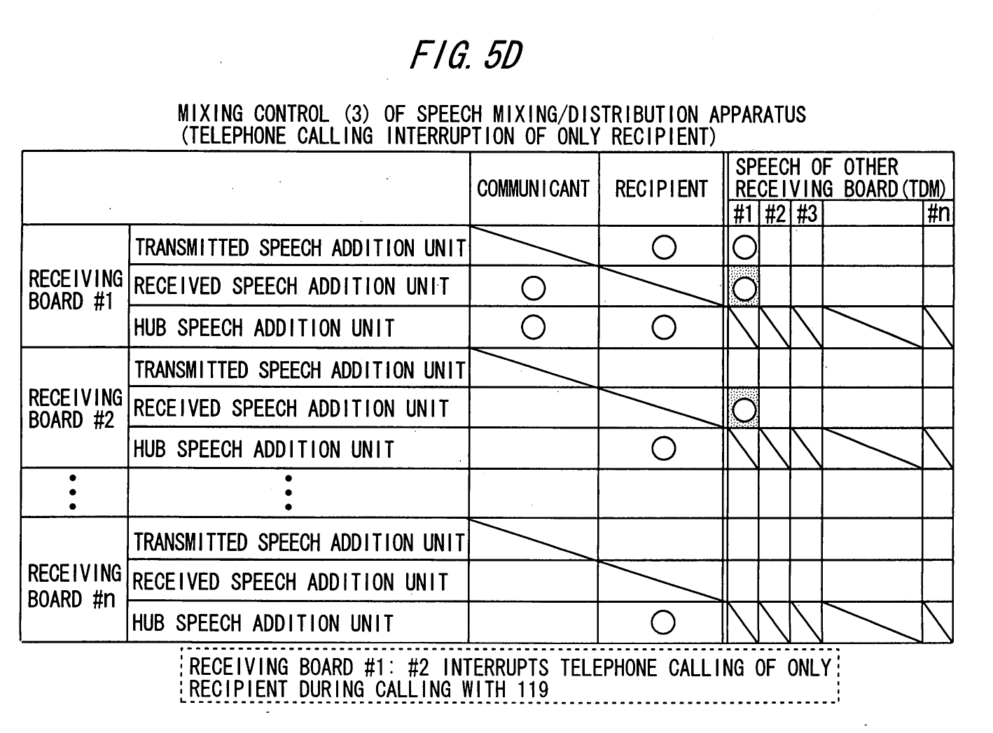

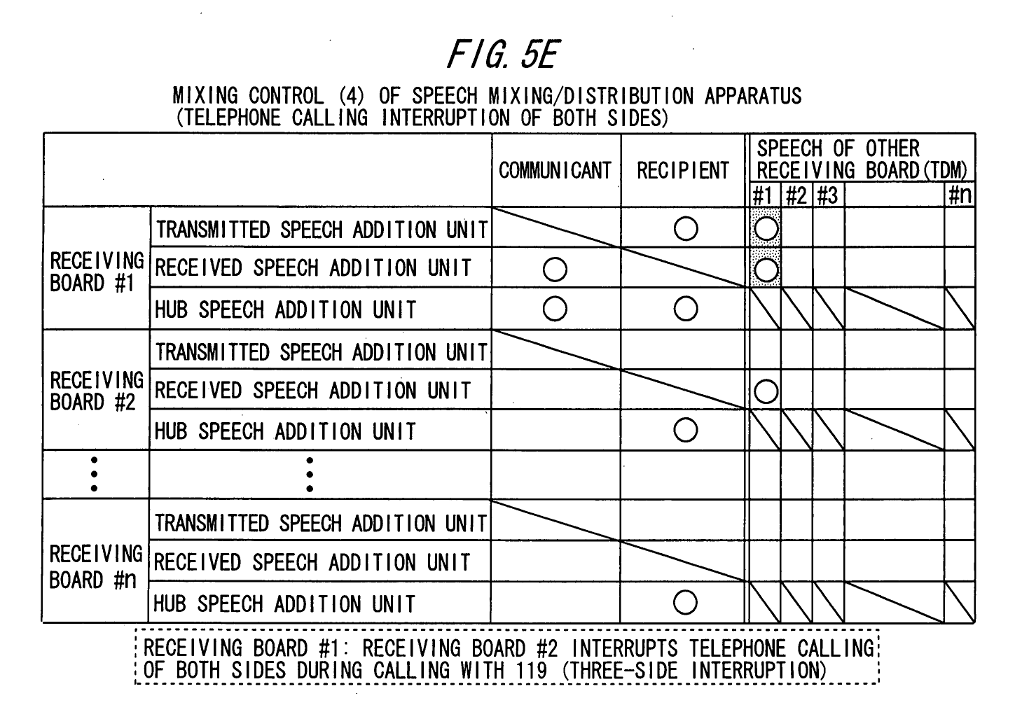

Specifically, the speech mixing/distribution apparatus 23 has a flag management table for addition control similar to, e.g., that shown in FIG. 5A. The flag management table is a collection of small tables prepared for the receiving boards. Each small table stores a flag indicating addition/nonaddition (OFF (0 or blank)=nonaddition, ON (1 or o)=addition) of the speech data of the communicant to the transmitted speech addition unit 45, the received speech addition unit 42, and the HUB speech addition unit 47 at the receiving board, the speech data of the recipient, and the speech data of the receiving boards (#1 to #30). However, in FIGS. 5A to 5E, shaded portions indicate that there are no relevant flags.

For example, in FIG. 5A, in the small table of the receiving board #1, the flag of the recipient to the HUB speech addition unit 47 is ON, and the flag of the communicant is OFF. This indicates that the HUB speech addition unit 47 of the receiving board #1 adds (outputs to the speech multiplexing HUB apparatus 30) speech data from the speech transmission unit 24B (A/D conversion unit 44), but does not add (does not output to the speech multiplexing HUB apparatus 30) speech data from the sound card 21A (A/D conversion unit 41).

In FIG. 5A, in the small table of the receiving board #1, the flag of the communicant to the transmitted speech addition unit 45 is ON, and the flag of the communicant to the received speech addition unit 42 is OFF. This indicates that the received speech addition unit 42 does not add (does not output to the speech reception unit 24A) a speech from the communicant (sound card 21A), and the transmitted speech addition unit 45 does not add (does not output to the sound card 21A) a speech from the recipient (speech transmission unit 24B).

Further, in FIG. 5A, in the small table of the receiving board #1, the flags of the receiving boards to the received speech addition unit 42 and the transmitted speech addition unit 45 are all OFF. This indicates that at the received speech addition unit 42 and the transmitted speech addition unit 45 of the receiving board #1, speech data (interruption speech) from the speech multiplexing HUB apparatus 30 is not added.

On the other hand, when the flags are ON, the speeches of the communicant, the recipient, and the receiving board are added at a corresponding addition unit.

Each PC 21 supplies control information (may be referred to as “addition information”) regarding the turning ON/OFF of the flags of the communicant and the recipient as control data to the microcomputer 48 based on the operation of the LCD 22. Each PC 21 receives a control packet (containing control data regarding interruption) based on the operation of the LCD 22 of the transmission side via the LAN, and supplies the control information (addition information) contained in the control packet to the microcomputer 48. Then, the microcomputer 48 controls the turning ON/OFF of the flags, i.e., addition processing by the addition units 42, 45, and 47, according to the control information received from the PC 21.

It is to be noted that a configuration can be employed in which the ON/OFF control of the flags is performed by the microcomputer 48. Alternatively, a configuration can be employed in which the microcomputer 48 notifies the control information to the addition units 42, 45, and 47, and executes addition processing for itself so as to set the addition units 42, 45, and 47 in states indicated by the small tables. Additionally, a configuration can be employed in which each receiving board apparatus 20 has a flag management table for all the receiving boards. Alternatively, a configuration can be employed in which only a small table corresponding to receiving board apparatus itself is provided. Needless to say, according to the present invention, it is not essential to provide the flag management table. It is only necessary to employ a configuration that the addition control and processing indicated by the flag management table are carried out by the PC 21 of each receiving board and the speech mixing/distribution apparatus 23.

As described above, each receiving board apparatus 20 has the following functions.

<1> The transmitted speech addition unit 45 of the speech mixing/distribution apparatus 23 adds together the transmitted speech of the recipient (speech from the speech transmission unit 24B) and the multiplexed calling contents of the other receiving board (speech from the speech multiplexing HUB apparatus 30), and sends the added speech to the communicant side (sound card 21A of the PC 21).

<2> The received speech addition unit 42 of the speech mixing/distribution apparatus 23 adds together the speech from the communicant side (sound card 21A of the PC 21) and the multiplexed calling contents of the other receiving board (speech from the speech multiplexing HUB apparatus 30), and outputs the added speech to the recipient (speech reception unit 24A).

<3> The HUB speech addition unit 47 of the speech mixing/distribution apparatus 23 adds together the transmitted speech of the recipient (speech from the speech transmission unit 24B) and the speech of the communicant side (sound card 21A of the PC 21), and outputs the added speech to the speech multiplexing HUB apparatus 30.

<4> In speech mixing, the PC 21 transmits/receives the both-side interruption information from the other receiving board via the LAN. The microcomputer 48 incorporated in the speech mixing/distribution apparatus 23 of the receiving board of the reception side controls the transmitted speech addition unit 45 as control unit based on the both-side interruption information.

<5> In speech mixing, the receiving board PC 21 transmits/receives the both-side interruption information or the recipient interruption information (interruption information only to the recipient) from the other receiving board via the LAN. The microcomputer 48 incorporated in the speech mixing/distribution apparatus 23 of the receiving board of the reception side controls the received speech addition unit 42 as control unit based on the interruption information.

<6> In speech mixing, the microcomputer 48 of the speech mixing/distribution apparatus 23 controls the HUB speech addition unit 47 as control unit based on the control information from the receiving board PC 21.

<7> As shown in the timing chart of FIG. 4, the speech multiplexing HUB apparatus 30 time-division multiplexes data (each receiving board 1 ch) of the speech (or calling speech) of each receiving board received from the speech mixing/distribution apparatus 23.

<8> As shown in the timing chart of FIG. 4, the speech multiplexing HUB apparatus 30 outputs the TDM data obtained by time-division multiplexing the speech data of n receiving boards in parallel to the speech mixing/distribution apparatus of all the receiving boards.

### OPERATION EXAMPLE

### Next, an operation example of the receiving system of Embodiment 1 will be described.

### OPERATION EXAMPLE 1

### Informing to Fire Station (Telephone Number “119”)

As Operation Example 1, there is emergency line informing from the communicant to the fire station (emergency telephone number: 119). For example, an operation example in the case of responding to a message by the receiving board #1 will be described. It is to be noted that a similar operation is performed in the case of responding by the other receiving board.

Upon detection of a call from the communicant (VoIP gateway apparatus 10), each PC 21 at each of all the receiving boards of the command center displays the incoming call (flashed displaying of relevant line button) to the LCD 22. At this time, an incoming call buzzer can be rung.

Now, consideration will be given to a case where the operator of the receiving board #1 responds to the call as a recipient. The operator of the receiving board #1 presses (touches by finger) the line button indicating call incoming (flashing). Then, the PC 21 of the receiving board #1 notifies a response signal to the VoIP gateway apparatus 10 via the LAN. Accordingly, telephone calling is established between the communicant and the receiving board #1. Then, the line button of the LCD 22 of the receiving board #1 indicates telephone calling (continuous lighting). On the other hand, at the LCD 22 of the other receiving board, the line button indicates a yellow lit state (receiving by the other receiving board).

Incidentally, the speech mixing/distribution apparatus 23 of the receiving board #1 is in a free state similar to that shown in FIG. 5A before responding to the call from the communicant. On the other hand, when the operator performs a response operation (presses the line button), corresponding control information is supplied from the PC 21 to the microcomputer 48. Then, based on the control information, the microcomputer 48 switches ON a flag of the recipient to the transmitted speech addition unit 45 of the receiving board #1 and a flag of the communicant to the received speech addition unit 42 and the HUB speech addition unit 47 (see FIG. 5B). Accordingly, the transmitted speech addition unit 45 is set in a state of adding (selecting and outputting) only speech data of the recipient. The received speech addition unit 42 is set in a state of adding (selecting and outputting) only speech data of the communicant.

Thus, when a speech packet containing a speech of the communicant is received by the PC 21 of the receiving board #1 via the LAN 11 from the VoIP gateway apparatus 10, the speech of the communicant is input from the PC 21 to the speech mixing/distribution apparatus 23, and is output from the speech reception unit 24A of the breast 24. Meanwhile, a speech of the recipient input to the speech transmission unit 24B of the breast 24 is passed through the speech mixing/distribution apparatus 23 and input to the PC 21. A speech packet generated by the PC 21 is transmitted to the VoIP gateway apparatus 10 via the LAN 11, and to the communicant. Accordingly, telephone calling (speech communication) is carried out between the communicant and the recipient of the receiving board #1 (see FIG. 1; <E1>).

The HUB speech addition unit 47 is set in a state of sending the speech data of the communicant to the speech multiplexing HUB apparatus 30. In other words, to enable the other receiving board to start telephone calling monitoring of the receiving board #1 at any time, the speeches of the recipient and the communicant are added together (mixed) and sent to the speech multiplexing HUB apparatus 30.

It is to be noted that a flag of the recipient to the HUB speech multiplexing unit 47 is always set ON (even in a free state) in this example. Thus, the speech of the recipient (speech from the speech transmission unit 24B) is always sent to the speech multiplexing HUB apparatus 30.

The speech multiplexing HUB apparatus 30 outputs TDM data obtained by time-division multiplexing speech data of the receiving boards in parallel to all the receiving boards. Thus, the telephone calling speech of the receiving board #1 (speeches of the communicant and the recipient) is distributed to the other receiving boards.

### OPERATION EXAMPLE 2

### Case of Monitoring Telephone Calling by Other Receiving Board

As Operation Example 2, an operation in the case of monitoring (checking) the telephone calling at the receiving board #1 by, e.g., a receiving board #2 will be described.

In the case of requesting assistance (support) to the operator of the other receiving board to supply proper information to the communicant, the recipient of the receiving board #1 presses the assistance request button of the LCD 22. Then, from the PC 21 of the receiving board #1, a packet containing the assistance request as control data is broadcast from the LAN 11 to the PC 21 of the other receiving board.

Based on the assistance request contained in the packet, the PC 21 of the other receiving board displays a corresponding monitor button of the LCD 22 (monitor button of the receiving board #1, here) by flashing. Accordingly, the operator of the other receiving board can know that the operator of the receiving board #1 requests assistance.

Now, consideration will be given to a case where the operator of the receiving board #2 assists the receiving board #1. In this case, the operator of the receiving board #2 presses (touches) the corresponding monitor button of the LCD 22 (“receiving board #1 monitor” button). Then, an operation signal compliant with the touched monitor button is input to the PC 21, and the PC 21 generates corresponding control information and supplies the control information to the microcomputer 48.

Then, based on the control information, the microcomputer 48 switches ON a flag of the receiving board #1 to the received speech addition unit 42 in the small table of the receiving board #2 (see FIG. 5C). Accordingly, the received speech addition unit 42 of the speech mixing/distribution apparatus 23 of the receiving board #2 adds speech data of a channel corresponding to the receiving board #1 among TDM data received from the speech multiplexing HUB apparatus 30, and outputs it to the breast 24. Thus, the operator of the receiving board #2 can monitor telephone calling of the receiving board #1 (see FIG. 1; <E2>).

It is to be noted that the operation is not changed even in the case of monitoring by a receiving board other than the receiving board #2.

It is to be noted that Embodiment 1 is configured to perform monitoring by taking an opportunity of the assistance request as described above. However, configuration can be employed in which each receiving board can monitor telephone calling at the other receiving board even if there is no assistance request.

### OPERATION EXAMPLE 3

### Case of Interrupting Telephone Calling from Other Receiving Board (Interruption to the Recipient Side)

As Operation Example 3, an operation when the operator of the receiving board #2 interrupts only the recipient side of telephone calling at the receiving board #1 will be described. A function of Operation Example 3 is used for rear-area assistance or the like from the other receiving board.

In the case of performing “operator interruption” for telephone calling, the operator of the receiving board #2 presses the “operator interruption” button of the LCD 22. Then, an operation signal is supplied from the LCD 22 to the PC 21. The PC 21 generates a control packet containing operator interruption information as control data, and transmits the control packet to the PC 21 of the receiving board #1 via the LAN.

Upon reception of the operator interruption information, the PC 21 of the receiving board #1 supplies an operator interruption notice of the receiving board #2 as control information to the microcomputer 48 of the speech mixing/distribution apparatus 23.

Then, based on the operator interruption notice (control information), as shown in FIG. 5D, the microcomputer 48 of the speech mixing/distribution apparatus 23 of the receiving board #1 switches ON a flag of the receiving board #2 to the received speech addition unit 42 in the small table of the receiving board #1. Accordingly, the received speech addition unit 42 of the receiving board #1 is set in a state of adding speech data of a channel of the receiving board #2 among TDM data received from the speech multiplexing HUB apparatus 30 and outputting the speech data to the breast 24.

Thus, the operator of the receiving board #2 can interrupt only the recipient side (operator) of the telephone calling at the receiving board #1. In other words, an interruption speech from the receiving board #2 can be transmitted only to the recipient of the receiving board #1. Needless to say, the recipient of the receiving board #1 can listen to a speech from the communicant.

Additionally, to always interrupt telephone calling, the HUB speech addition unit 47 of the receiving board #1 adds only a transmitted speech from the breast 24 and outputs the speech to the speech multiplexing HUB apparatus 30.

It is to be noted that the operation of Operation Example 3 is similarly performed even when a receiving board other than the receiving board #2 interrupts.

### OPERATION EXAMPLE 4

### Case of Interrupting Telephone Calling from Other Receiving Board (Interruption to Both Sides)

As Operation Example 4, for example, an operation when the operator of the receiving board #2 interrupts both sides of telephone calling at the receiving board #1 will be described. A function of Operation Example 4 is used when contents of telephone calling require immediate attention, the other operator wishes to directly interrupt the telephone calling, or the like.

In the case of interrupting both sides of telephone calling, the operator of the receiving board #30 presses the “both-side interruption” button of the LCD 22 of the receiving board #2. Then, an operation signal corresponding to the pressed button is supplied to the PC 21 of the receiving board #2. The PC 21 generates a control packet containing both-side interruption information as control data, and transmits the control packet to the PC 21 of the receiving board #1 via the LAN.

Upon reception of the both-side interruption information, the PC 21 of the receiving board #1 supplies a both-side interruption notice of the receiving board #2 as control information to the speech mixing/distribution apparatus 23 of the receiving board #1. Then, based on the control information, as shown in FIG. 5E, the microcomputer 48 of the speech mixing/distribution apparatus 23 of the receiving board #1 switches ON the flag of the receiving board #2 to the transmitted speech addition unit 45 and the received speech addition unit 42 in the small table of the receiving board #1.

Accordingly, the received speech addition unit 42 of the receiving board #1 is set in a state of adding speech data of a channel of the receiving board #2 among TDM data received from the speech multiplexing HUB apparatus 30 and outputting the speech data to the breast 24. Thus, a state is set in which the speech of the communicant and the speech of the operator of the receiving board #2 are output from the speech reception unit 24A of the breast 24 of the receiving board #1.

Simultaneously, the transmitted speech addition unit 45 of the receiving board #1 is set in a state of adding the speech data of the channel of the receiving board #2 among the TDM data received from the speech multiplexing HUB apparatus 30, and outputting the speech data to the communicant side (sound card 21A of the receiving board #1). Accordingly, the communicant can listen to the speech of the recipient of the receiving board #1 and the speech of the operator of the receiving board #2.

It is to be noted that in FIG. 1, a route of the interruption speech when the operator of the receiving board #30 interrupts both sides of the telephone calling of the receiving board #1 is shown as <E3>.

In Operation Examples 1 to 4, in the case of finishing the telephone calling, the monitoring, and the interrupting, the operator of the relevant receiving board carries out the aforementioned predetermined operations (disconnecting operation, monitor releasing operation, and interruption releasing operation) for the LCD 22 of the receiving board. Then, addition information compliant with the predetermined operations is supplied from the PC 21 to the microcomputer 48. The microcomputer 48 switches the corresponding flag from ON to OFF. Thus, the addition processing executed at the corresponding addition unit when the flag is ON is stopped.

Furthermore, in Operation Examples 1 to 4, for example, the recipient of the receiving board #1 can transmit a command to the branch office through the LAN 11 the private line.

[Effects]

According to Embodiment 1 described above, the receiving system includes the plurality of receiving board apparatus 20, and enables monitoring and interruption of telephone calling between the receiving board apparatus 20. At this time, the speech data of the speech for telephone calling monitoring and the interruption speech are sent to the speech multiplexing HUB apparatus (TDM) 30, time-division multiplexed at the speech multiplexing HUB apparatus 30, and distributed to the other receiving board apparatus 20.

Meanwhile, the control data regarding the monitoring or the interruption is transmitted/received between the receiving board apparatus via the LAN for connecting each receiving board apparatus to transmit the speech packet of the telephone calling to the VoIP gateway apparatus 10.

With such a configuration, since the speech for the monitoring or the interruption is not transmitted through the LAN, a packet data amount in the LAN can be limited, and traffic of the LAN can be maintained in a smooth state. Accordingly, the occurrence of congestion is suppressed. Thus, a packet delay can be prevented. As a result, it is possible to perform communication for call control of an incoming call notice or the like from the communicant, speech data communication between the receiving board which has responded and the communicant, and the like properly.

Furthermore, the speech data for the monitoring or the interruption is distributed to the other receiving board apparatus 20 without being subjected to VoIP processing (compressing and encoding or formation into packet). Accordingly, a speech delay or fluctuation caused by the VoIP processing can be prevented. Thus, in the adjacent receiving boards, it is possible to eliminate hearing difficulty caused by delayed hearing of a live speech from the operator of one receiving board from the breast 24 at the other receiving board.

The receiving system according to Embodiment 1 has the following advantages.

(1) Cost

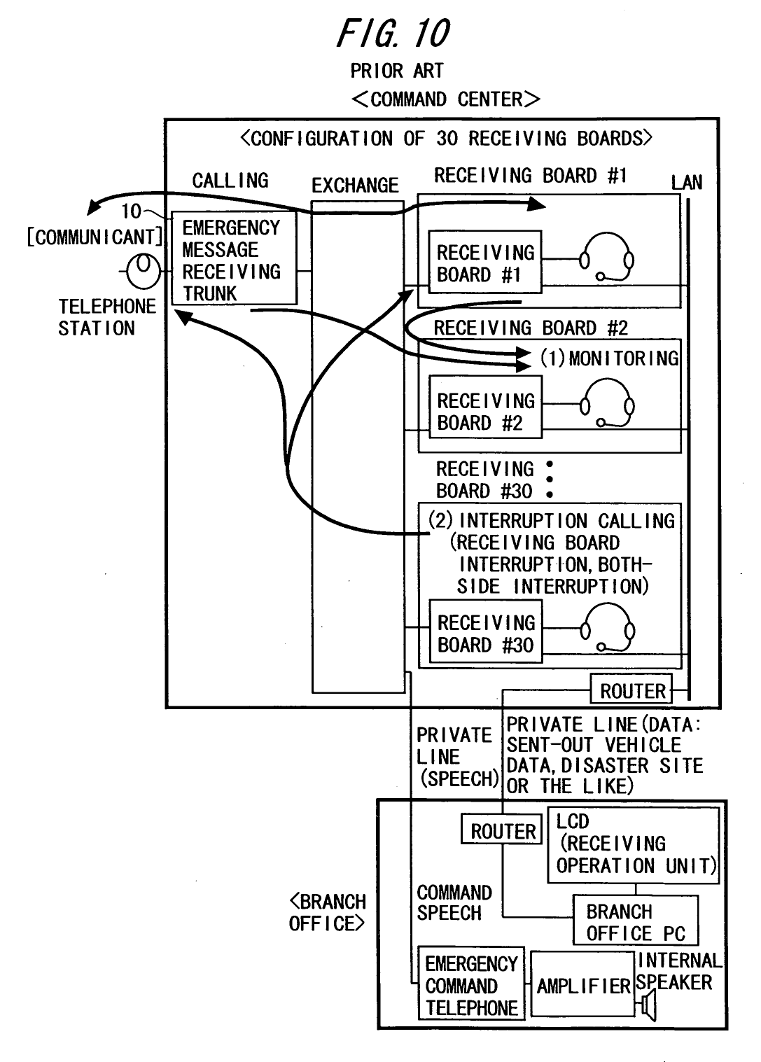

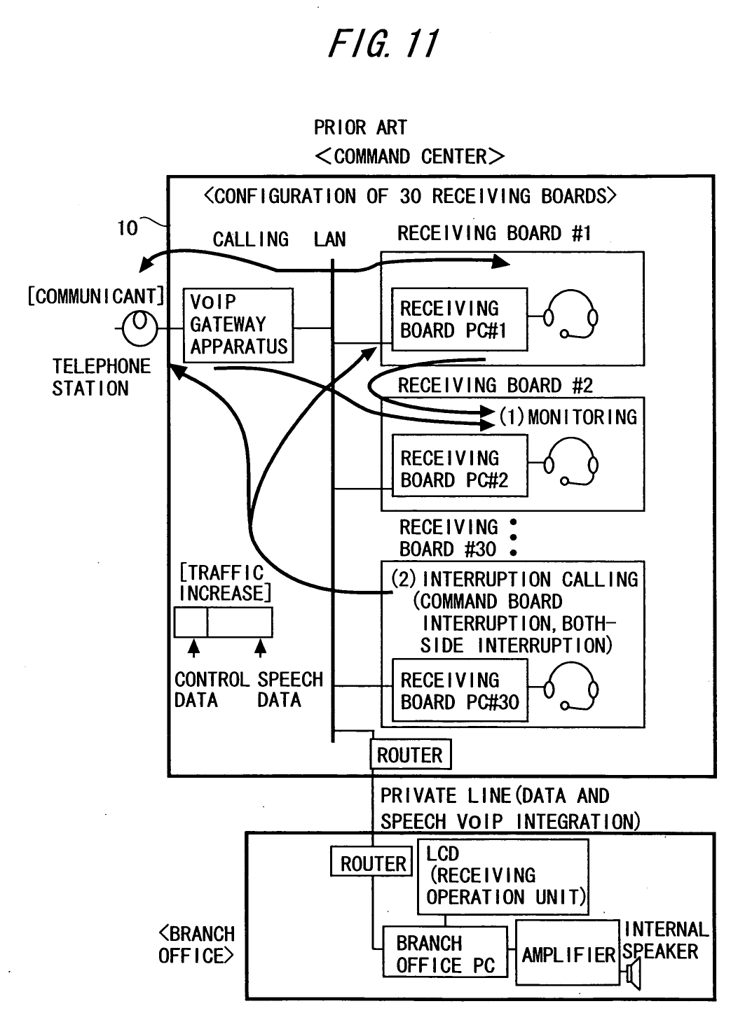

The message receiving system according to Embodiment 1 does not use any exchanges. Thus, it is possible to reduce costs of apparatus necessary for system configuration. Additionally, unlike the prior art shown in FIG. 10, the command line for interconnecting the command center and each branch office can be constituted of one line integrating a speech and control data. Thus, it is possible to reduce line communication costs.

(2) Size

The message receiving system according to Embodiment 1 does not use any exchanges. Accordingly, the system becomes compact (miniaturized). A modular connection can be made via a LAN cable between the VoIP gateway apparatus 10 and each PC 21. Thus, since the MDF is made unnecessary, an accommodation space of the MDF can be omitted.

(3) Performance

The message receiving system according to Embodiment 1 is configured as an IP system which does not use the exchange. Even with this configuration, it is possible to prevent adverse effects of the speech delay. As described later, rear-area assistance can be provided from the remote place.

### Embodiment 2

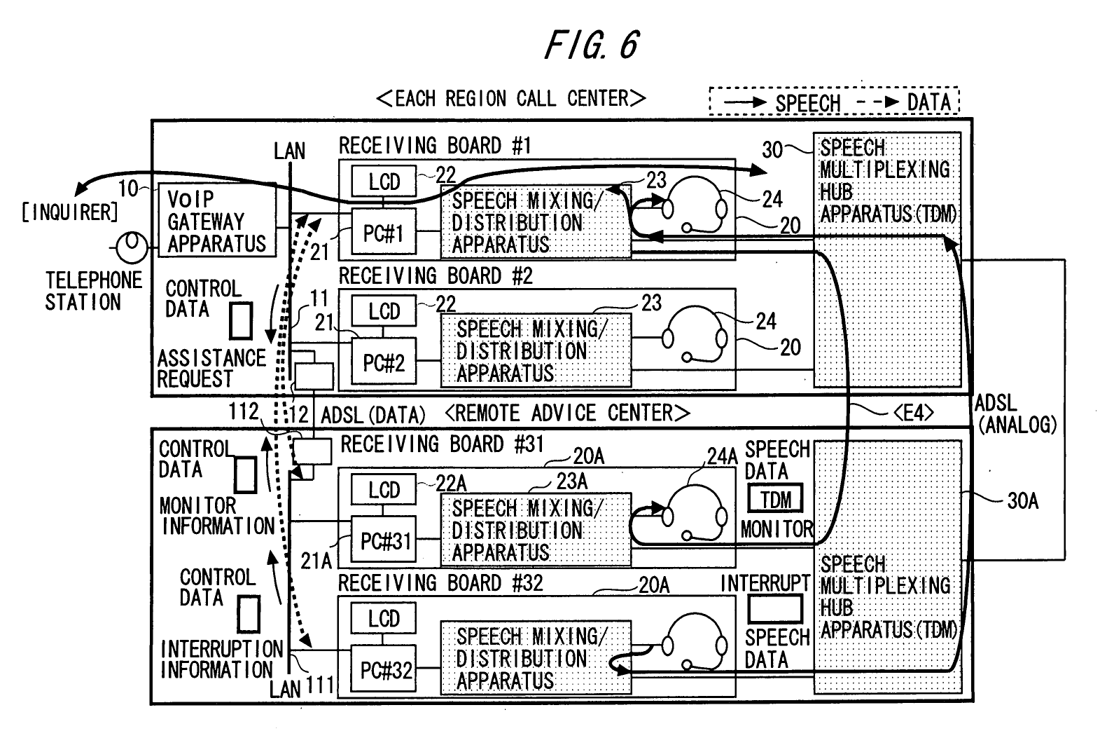

FIG. 6 is a system configuration diagram showing Embodiment 2. FIG. 6 shows a receiving system which includes a call center of each region (only one is shown in FIG. 6) and a remote advice center. In FIG. 6, the call center has a configuration similar to that of the command center shown in FIG. 1.

That is, the call center includes a VoIP gateway-apparatus 10 connected to a carrier network (telephone network), a plurality (n) of receiving board apparatus 20 (two receiving board apparatus 20 are shown in FIG. 6), and a speech multiplexing HUB apparatus 30. Each receiving board apparatus 20 includes a PC 21 connected to the VoIP gateway apparatus 10 via a LAN 11 in the call center, an LCD 22 and a speech mixing/distribution apparatus 23 connected to the PC 21, and a breast 24 connected to the speech mixing/distribution apparatus 23. Each speech mixing/distribution apparatus 23 is connected to the speech multiplexing HUB apparatus 30.

The remote advice center has a configuration similar to that of the call center except for the fact that there is no VoIP gateway apparatus 10. That is, the remote advice center includes at least one receiving board apparatus 20A connected via a LAN 111 therein, and a speech multiplexing HUB apparatus 30A. As in the case of the receiving board apparatus 20, the receiving board apparatus 20A includes a PC 21A connected to the LAN 111, an LCD 22A and a speech mixing/distribution apparatus 23A connected to the PC 21A, and a breast 24 connected to the speech mixing/distribution apparatus 23A. The speech mixing/distribution apparatus 23A is connected to the speech multiplexing HUB apparatus 30A.

Functions of the receiving board apparatus 20 and 20A shown in FIG. 6 are substantially similar to that of the receiving board apparatus 20 shown in FIG. 1, and thus detailed description thereof will be omitted. However, the system shown in FIG. 6 is different from the system shown in FIG. 1 in the following respects.

First, the LAN 11 of the call center and the LAN 111 of the advice center respectively accommodate routers 12 and 112. Those routers 12 and 112 are interconnected via, e.g., an ADSL (data) line. Accordingly, each PC 21A in the advice center can transmit/receive a packet to/from each PC 21 in the call center. For example, each PC 21 of the advice center can transmit a control packet regarding interruption to a desired PC 21 in the call center via the LAN 111 according to an operation of the corresponding LCD 22.

Meanwhile, the speech multiplexing HUB apparatus 30 in the call center and the speech multiplexing HUB apparatus 30A in the advice center are interconnected via an analog line (e.g., analog ADSL line). Each of the speech multiplexing HUB apparatus 30 and 30A is configured to be capable of distributing TDM data obtained by time-division multiplexing speech data of all the receiving boards in each of the call center and the advice center to each speech mixing/distribution apparatus 23 (23A) which it accommodates itself.

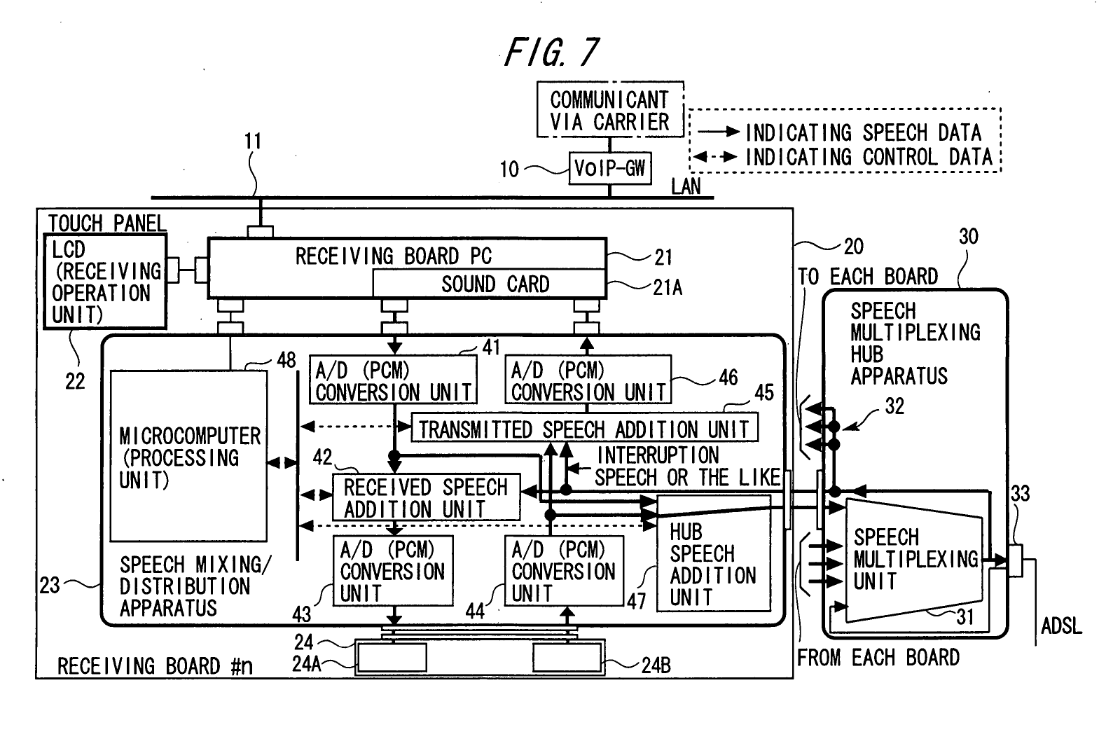

That is, as shown in FIG. 7, the speech multiplexing HUB apparatus 30 of Embodiment 2 has a telephone interface 33 to which the analog line is connected. TDM data from a speech multiplexing unit 31 is sent to the analog line via the telephone interface 33, and is transmitted to the speech multiplexing HUB apparatus 30A.

The TDM data from the speech multiplexing HUB apparatus 30A is structured to be input to the speech multiplexing unit 31 via the telephone interface 33. Then, the speech multiplexing HUB apparatus 30 further has a channel (time slot) prepared corresponding to each receiving board in the advice center. The TDM data from the speech multiplexing HUB apparatus 30A are contained in the TDM data of the speech multiplexing HUB apparatus 30, and they are passed in parallel to the receiving boards (speech mixing/distribution apparatus 23) in the call center.

The speech multiplexing HUB apparatus 30A has a configuration substantially similar to that of the speech multiplexing HUB apparatus 30 shown in FIG. 7, and is configured to be capable of distributing speech data from the respective receiving board apparatus 20 in the call center which are received from the speech multiplexing HUB apparatus 30 in parallel to the receiving board apparatus 20A in the advice center.

The microprocessor 48 of each speech mixing/distribution apparatus 23 is configured to be capable of controlling addition/nonaddition (execution/nonexecution of addition processing) of addition units 42 and 45 for speech data of the receiving boards #1, #2, #31, and #32 received from the speech multiplexing HUB apparatus 30 for each addition unit and each receiving unit according to control data (addition information) from the PC 21.

Additionally, the microprocessor 48 of each speech mixing/distribution apparatus 23A is configured to be capable of controlling addition/nonaddition of the addition units 42 and 45 for speech data of the receiving boards #1, #2, #31, and #32 received from the speech multiplexing HUB apparatus 30A for each addition unit and each receiving board according to control information (addition information) from the PC 21A.

With the configuration, an operator of each receiving board in the advice center can monitor telephone calling at a desired receiving board in the call center, and interrupt (operator interruption or both-side interruption) when necessary.

As described above, according to Embodiment 2, the call center and the advice center are interconnected by using the data ADSL line and the analog ADSL line, and a function of providing rear-area assistance at the remote advice center when a high-level question (inquiry) comes to the call center is realized. In other words, the ADSL line or the like is used, and speech communication (transmission/reception of speech data for monitoring or interruption) is carried out by using the analog line for interconnecting the speech multiplexing HUB apparatus 30 and 30A. Control communication (transmission/reception of control data for monitoring, interruption, or the like) is carried out by using the data line (LAN 11, router 12, ADSL line, router 112, and LAN 111) for interconnecting the PC's 21 and 21A.

An operation example of Embodiment 2 will be described. It is assumed that in FIG. 6, at the call center, for example, the operator of the receiving board #1 as a recipient communicates with an inquirer.

At this time, when a high-level question comes from the inquirer, the recipient of the receiving board #1 presses a remote assistance request button of the LCD 22. Then, an operation signal compliant with the remote assistance request button is supplied to the PC 21. The PC 21 lights the remote assistance request button, generates a control packet containing assistance request information as control data, and transmits the control packet to the PC 21A of each receiving board in the advice center via the data line (LAN 11—router 12—ADSL (data)—router 112—LAN 111).

Each PC 21A that has received the control packet displays an assistance request in the LCD 22 (e.g., flashing of a monitor button of the receiving board #1). At this time, a buzzer sound can be output from a sound card to indicate the assistance request.

Consideration will be given to a case where an operator of a certain receiving board (e.g., receiving board #31) in the advice center performs a response operation to the LCD 22 (presses the monitor button of the receiving board #1) for the assistance request. Then, an operation (control of the speech mixing/distribution apparatus 23A) similar to that of the receiving board apparatus 20 at the time of starting monitoring described above in Operation Example 2 of Embodiment 1 is performed at the receiving board apparatus 20A of the receiving board #31.

Accordingly, a received speech addition unit 42 of the speech mixing/distribution apparatus 23A of the receiving board #31 is set in a state of adding speech data of the receiving board #1 input from the speech multiplexing HUB apparatus 30A. Thus, telephone calling (speeches of the inquirer and the recipient) at the receiving board #1 is output from a speech reception unit 24A of the breast 24 of the receiving board #31, enabling the operator of the receiving board #31 to monitor contents of the telephone calling (see FIG. 6; <E4>). It is to be noted that by a response operation to the assistance request, a packet containing information indicating monitoring by the receiving board #31 is transmitted to the PC 21 of the receiving board #1 via the data line. When the PC 21 receives this packet, the light of the remote assistance request button is put off. Thus, the operator of the receiving board #1 can learn that the remote assistance has been received and monitoring is currently being executed.

Then, in the case of supplying an advice (interruption speech) to the recipient of the receiving board #1 or both of the recipient and the inquirer as rear-area assistance, the operator of the receiving board #31 operates the LCD 22 of the receiving board #31, and transmits a speech packet containing control data for desired interruption to the PC 21 of the receiving board #1 via the data communication line.

Then, at the receiving board #1, control of the speech mixing/distribution apparatus 23 for interruption similar to that of Operation Example 3 or 4 is carried out. An interruption speech from the receiving board #31 is transmitted from the speech multiplexing HUB apparatus 30A to the speech multiplexing HUB apparatus 30 via the analog line, and input from the speech multiplexing HUB apparatus 30 to the speech mixing/distribution apparatus 23 of the receiving board #1. At this time, if the interruption is “recipient interruption”, the interruption speech is transmitted only to the recipient by addition processing of the received speech addition unit 42. If the interruption is “both-side interruption”, the interruption speech is transmitted to the inquirer and the recipient by addition processing of the received speech addition unit 42 and the transmitted speech addition unit 45.

To realize the aforementioned operation, each receiving board apparatus 20 of the call center has flags of the receiving boards #31 and #32 for the received speech addition unit 42 and the transmitted speech addition unit 45, sets those corresponding flags ON at the time of interruption, and the received speech addition unit 42 and the transmitted speech addition unit 45 select the interruption speech to perform addition processing.

It is to be noted that FIG. 6 shows, as a both-side interruption example, a transmission route of speech data of an interruption speech when the operator of the receiving board apparatus #32 of the advice center performs both-side interruption for the telephone calling of the receiving board #1 (see FIG. 6; <E5>).

According to Embodiment 2, the advice center can give rear-area assistance to the call center from a remote place. Needless to say, the call center can obtain operations and effects similar to those of the receiving system in the command center shown in FIG. 1.

### Embodiment 3

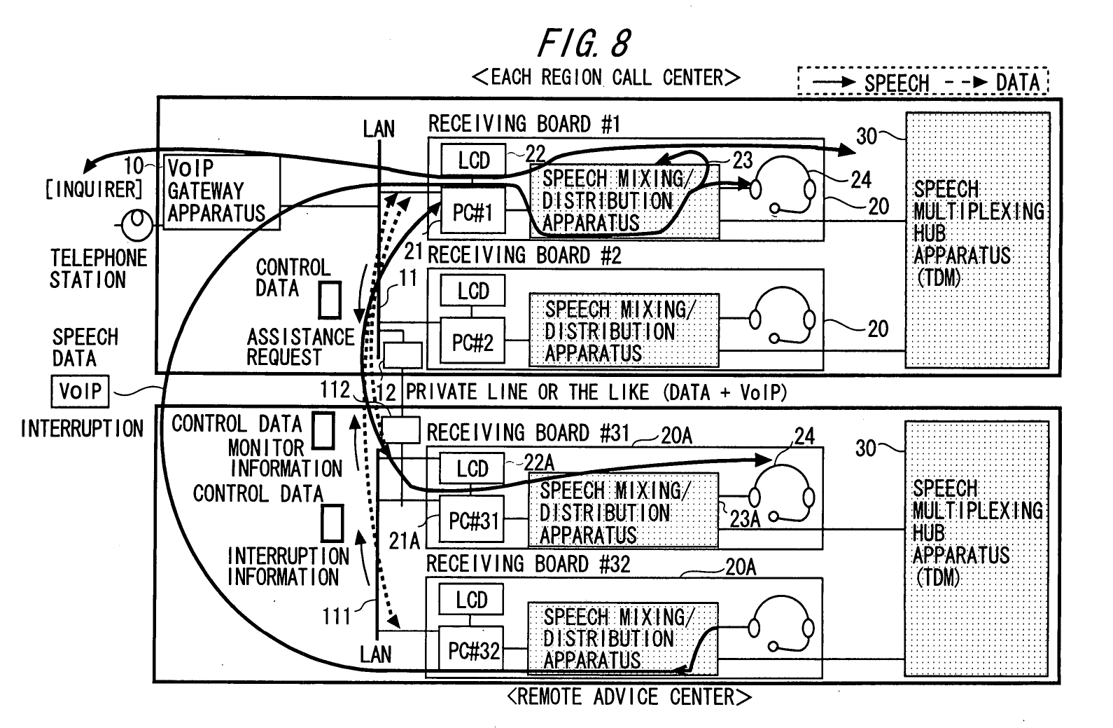

FIG. 8 is a system configuration diagram showing Embodiment 3. The system configuration of Embodiment 3 shown in FIG. 8 is roughly similar to Embodiment 2 shown in FIG. 6, and enables an advice center to give rear-area assistance when a high-level question or the like comes to a call center. However, Embodiment 3 is different from Embodiment 2 in the following respects.

As shown in FIG. 8, the call center and the advice center are interconnected by connecting routers 12 and 112 of the centers to each other through a private line or the like. The private line is a line in which a data line and a VoIP (speech packet line) are integrated. For a speech multiplexing HUB apparatus of each center, the speech multiplexing HUB apparatus 30 described above with reference to Embodiment 1 is applied, and the speech multiplexing HUB apparatus are not interconnected through an analog line as in the case of Embodiment 2.

According to Embodiment 3, communication of a speech for monitoring or interruption of telephone calling in the call center at one or more receiving boards (FIG. 8 shows two receiving boards #31 and #32) in the advice center is carried out by VoIP communication (speech packet communication) using a data line for interconnecting the call center and the advice center (LAN 11 of call center—router 12—private line—router 112—LAN 111 of advice center).

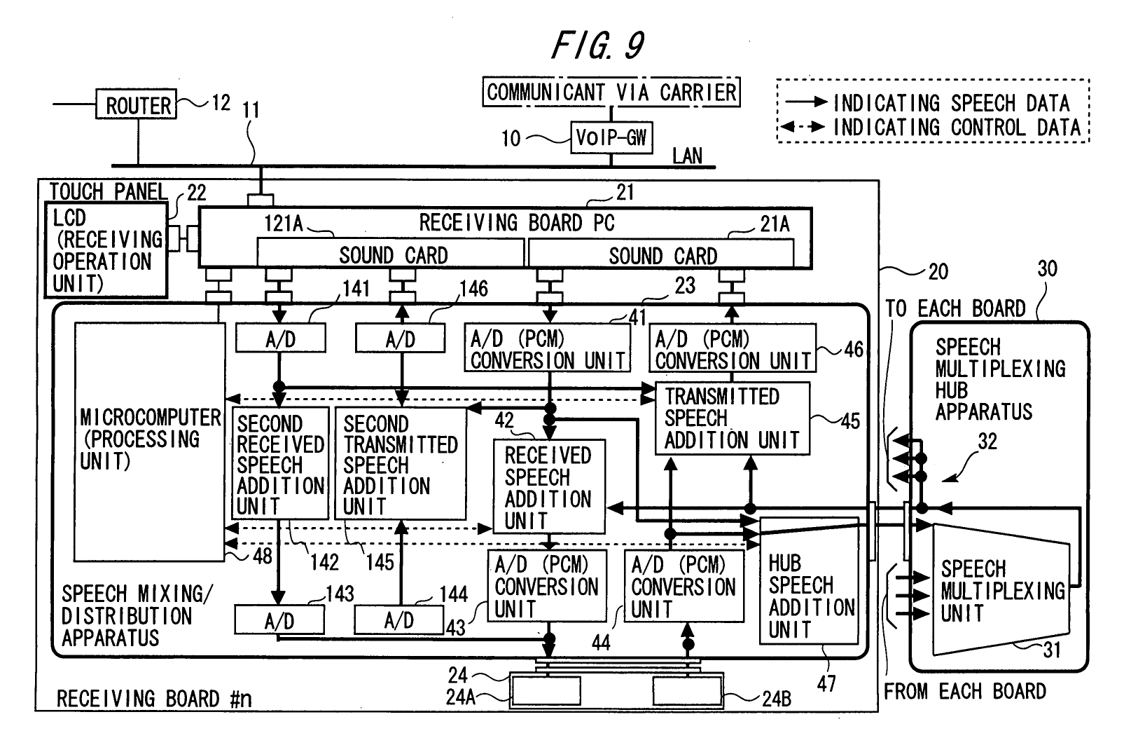

Thus, each receiving board apparatus 20 of Embodiment 3 has configuration similar to that shown in FIG. 9. FIG. 9 is a diagram showing a configuration example of the receiving board apparatus 30 of Embodiment 3.

The receiving board apparatus 20 shown in FIG. 9 is different from the receiving board apparatus shown in FIG. 2 in the following manner. That is, a PC 21 includes a sound card 121A for a speech regarding a speech packet transmitted to/received from the receiving board apparatus 20A of the advice center.

In addition to the components shown in FIG. 1, a speech mixing/distribution apparatus 23 includes an A/D conversion unit (PCM codec) 141 connected to a speech output unit of the sound card 121A via an interface, a second received speech addition unit 142 connected to the A/D conversion unit 141, an A/D conversion unit (PCM codec) 143 connected to the second received speech addition unit 142 and to a speech reception unit 24A of a breast 24 via an interface, an A/D conversion unit (PCM codec) 144 connected to a speech transmission unit 24B of the breast 24 via an interface, a second transmitted speech addition unit 145 connected to the A/D conversion unit 144, and an A/D conversion unit (PCM codec) 146 connected to the second transmitted speech addition unit 145 and to a speech input unit of the sound card 121A via an interface.

Functions of the A/D conversion units 141, 143, 144, and 146 are similar to those of the A/D conversion units 41, 43, 44, and 46. The second received speech addition unit 142 and the second transmitted speech addition unit 145 are similar in configuration to the received speech addition unit 42 and the transmitted speech addition unit 45, respectively, in that they are connected to a microcomputer 48 via a control line and select/output speech data input to themselves according to control of the microcomputer 48.

The second transmitted speech addition unit 45 is configured to receive speech data from the A/D conversion unit 41. The transmitted speech addition unit 45 is configured to receive speech data from the A/D conversion unit 141.

An operation example of Embodiment 3 is as follows. It is assumed that at the call center an operator (recipient) of a certain receiving board (e.g., receiving board #1) communicates with an inquirer, and the recipient receives a high-level question from the inquirer.

In this case, the recipient presses a remote assistance request button of an LCD 22. Then, a PC 21 of the receiving board #1 generates a packet containing control data regarding assistance request, and transmits the packet to PC's 21A of the receiving boards #31 and #32 of the advice center by using the data line.

Each PC 21A displays a remote assistance request on an LCD 22A. An operator of each of the receiving boards #31 and #32 can respond to the assistance request by an operation of the LCD 22A. At this time, for example, it is assumed that the operator of the receiving board #31 responds.

Then, the PC 21A of the receiving board #31 transmits a packet containing control data indicating monitoring of telephone calling of the receiving board #1 to the PC 21 of the receiving board #1 through the data line. Upon reception of the packet, the PC 21 supplies control information regarding the monitoring to the microcomputer 48 of the speech mixing/distribution apparatus 43.

The microcomputer 48 performs the following control according to the control information. That is, the microcomputer 48 executes setting to cause the second transmitted speech addition unit 45 to add together (select and output) speech data of the recipient and speech data of the inquirer.

By the setting, a speech of the inquirer output from the sound card 21A is passed through the A/D conversion unit 41, the received speech addition unit 42, and the A/D conversion unit 43 and output from the speech reception unit 24A of the breast 24. At this time, the speech data output from the A/D conversion unit 41 is also input to the second transmitted speech addition unit 145. The second transmitted speech addition unit 145 outputs the input speech data to the A/D converter 146 according to the setting. The output speech data is converted into a speech signal at the A/D conversion unit 146, and input to the sound card 121A. Then, the PC 21 generates a speech packet containing the speech input to the sound card 121A, and sends the speech packet addressed to the PC 21A of the receiving board #31 to the LAN 11.

A speech input from the speech transmission unit 24B of the breast 24 of the receiving board #1 is passed through the A/D conversion unit 44, the transmitted speech addition unit 45, and the A/D conversion unit 46, input to the sound card 21A, and sent to the inquirer. Additionally, a speech input from the speech transmission unit 24B is input to the A/D conversion unit 144, converted into speech data here, and input to the second transmitted speech addition unit 145. The second transmitted speech addition unit 145 outputs the input speech data to the A/D conversion unit 146 according to the setting. The output speech data is converted into a speech signal at the A/D converter 146, and input to the sound card 121A. Then, the PC 21 generates a speech packet containing the speech input to the sound card 121A, and sends the speech packet addressed to the PC 21A of the receiving board #31 to the LAN 11.

As described above, in the case of monitoring the telephone calling at the receiving board #1, at its receiving board apparatus 20, a speech packet containing a communication speech (speech of an inquirer and/or speech of a recipient) is generated, and transmitted to the PC 21A (PC 21A of the receiving board #31) of the assistance (support) source receiving board in the advice center.

The receiving board apparatus 20A of the receiving board #31 receives the speech packet, and outputs the speech contained therein from the speech reception unit 24A of the breast 24. Thus, the operator of the receiving board #31 can hear monitoring target telephone calling.

Subsequently, in the case of performing recipient interruption or both-side interruption, the operator (supporter) of the receiving board #31 presses a corresponding button of the LCD 22A. Then, the PC 21 of the receiving board #31 generates a packet containing interruption information (recipient interruption information or both-side interruption information) as control data, and transmits the packet to the PC 21 of the receiving board #1 via the data line.

Upon reception of the packet, the PC 21 of the receiving board #1 supplies the interruption information contained therein as control information to the microprocessor 48 of the speech mixing/distribution apparatus 23. The microcomputer 48 performs the following control based on the interruption information. That is, the microcomputer 48 executes setting to cause the second received speech addition unit 142 to add (select and output) speech data of the supporter (speech data of the receiving board #31). At this time, if the interruption information is both-side interruption information, the microcomputer 48 executes setting to cause the transmitted speech addition unit 45 to add (select and output) the speech of the supporter (speech data of the receiving board #31).

Subsequently, at the receiving board #31, when a speech (interruption speech) of the supporter is input from the speech transmission unit 24B of the breast 24, the PC 21A generates a speech packet containing the interruption speech, and transmits the speech packet to the PC 21 of the receiving board #1 through the data line. For example, the PC 21 recognizes that the speech packet is a packet of an interruption speech from a transmission source address of the speech packet, and passes the interruption speech contained in the speech packet to the sound card 121A. The sound card 121A passes the interruption speech to the A/D conversion unit 141 of the speech mixing/distribution apparatus 23.

Then, the interruption speech is passed through the A/D conversion unit 141, the second received speech addition unit 142, and the A/D conversion unit 143, and output from the speech reception unit 24A of the breast 24. Thus, recipient interruption is realized.

Incidentally, the speech data of the interruption speech output from the A/D conversion unit 141 is input to the second received speech addition unit 142 and the transmitted speech addition unit 45. At this time, if the interruption is both-side interruption, the transmitted speech addition unit 45 adds the speech data of the interruption speech according to setting executed for itself, and outputs the speech data to the A/D conversion unit 46. On the other hand, if the interruption is recipient interruption, setting for adding the speech data of the interruption speech is not executed for the transmitted speech addition unit 45. Thus, the transmitted speech addition unit 45 does not output the speech data of the interruption speech to the A/D conversion unit 46.

The speech data of the interruption speech input to the A/D conversion unit 46 is converted into a speech signal, and input to the sound card 21A. Then, the PC 21 generates a speech packet containing the interruption speech, and transmits the speech packet to the VoIP gateway apparatus 10 (inquirer). Thus, both-side interruption is realized.

It is to be noted that FIG. 8 shows, as a both-side interruption example, a transmission route of an interruption speech when the operator (supporter) of the receiving board apparatus #32 of the advice center performs both-side interruption for the telephone calling of the receiving board #1 (see FIG. 6; <E5>).

According to Embodiment 3, the advice center can give rear-area assistance to the call center from a remote place. Needless to say, the call center can obtain operations and effects similar to those of the receiving system in the command center shown in FIG. 1.

According to Embodiment 3, different from Embodiment 2, the analog line for the speech data is made unnecessary. Thus, modification of the speech multiplexing HUB apparatus 30 shown in FIG. 7 is made unnecessary. However, in Embodiment 3, the speech data regarding the monitoring or the interruption is transferred through the data line (LAN). Accordingly, traffic through the LAN of the call center may be increased more than that of Embodiment 2. However, the monitoring or the interruption for rear-area assistance (support) is not constantly carried out. Thus, the increase of traffic through the LAN is only temporary.

Additionally, the configuration is employed in which the speech for monitoring is transmitted to the remote receiving board through the data line. However, since the address of the speech is a remote place, there are no adverse effects of a speech delay or fluctuation described above in Embodiment 1.

It is to be noted that the present invention can be specified as follows.

(1) A speech selection and output apparatus including: a first output unit (e.g., received speech addition unit) for selecting and outputting at least one of first speech data (e.g., speech of an inquirer) and second speech data (e.g., speech from the other receiving board); a second output unit (e.g., transmitted speech addition unit) for selecting and outputting at least one of third speech data (e.g., speech of a recipient) and the second speech data; a third output unit (e.g., HUB speech addition unit) for selecting and outputting at least one of the first speech data and the second speech data; and a control unit (e.g., microcomputer) for controlling selecting and outputting operations of the first, second, and third units.

(2) The speech selection and output apparatus as described in (1), wherein the first and second output units select and output at least one of a plurality of time-division multiplexed third speech data.

(3) The speech selection and output apparatus as described in (2), wherein the first and second output units receive the plurality of time-division multiplexed third speech data from a time-division multiplexing apparatus (e.g., speech multiplexing HUB apparatus) for time-division multiplexing first and/or second speeches output from third output unit of a plurality of speech selection and output apparatus as third speech data.

(4) The speech selection and output apparatus as described in any one of (1) to (3), further including a fourth output unit (e.g., second transmitted speech addition unit) capable of selecting and outputting at least one of the first and third data, wherein the control unit controls a selecting and outputting operation of the fourth unit.

(5) The speech selection and outputting apparatus as described in (4), further including a fifth output unit (e.g., second received speech addition unit) capable of selecting and outputting fourth speech data (e.g., speech of remote supporter), wherein the second output unit can further select and output the fourth speech data, and the control unit controls selecting and outputting operations of the fourth and fifth output unit.

The present invention can be applied to various receiving systems for receiving inquiries by speeches of telephones or the like, such as an emergency message receiving system by a telephone of a police station, a fire station, or the like, a call center for receiving a telephone inquiry from an inquirer, and a local government network system for receiving an inquiry from a resident or the like.

The disclosures of international application PCT/JP2003/01986 filed on Feb. 24, 2003 including the specification, drawings and abstract are incorporated herein by reference.

1. A system for receiving an inquiry by a speech, comprising:
a plurality of receiving board apparatus for receiving an inquiry by a speech from an inquirer;
a VoIP (voice over internet protocol) gateway apparatus connected to the plurality of receiving board apparatus via a LAN (local area network) to transmit/receive a speech packet containing speech data regarding telephone calling between a recipient of a receiving board apparatus which responds to the inquiry and the inquirer to/from the receiving board apparatus; and
a speech multiplexing HUB apparatus for receiving speech data input to each receiving board apparatus therefrom, time-division multiplexing the speech data, and distributing the speech data in parallel to the respective receiving board apparatus.

2. A system for receiving an inquiry by a speech according to claim 1, wherein:
each receiving board apparatus includes a control unit, a speech mixing/distribution apparatus, a speech output unit, and a speech input unit;
the control unit supplies the speech of the inquirer contained in the speech packet received from the VoIP gateway apparatus to the speech mixing/distribution apparatus, generates a speech packet containing the speech received from the speech mixing/distribution apparatus as a speech to be sent to the inquirer, and transmits the speech packet to the VoIP gateway apparatus; and
the speech mixing/distribution apparatus includes:
a received speech selection unit for selecting at least one of speech data regarding the speech of the inquirer and speech data of the other receiving board apparatus input from the speech multiplexing HUB apparatus as a speech to be output from the speech output unit, and outputting the speech data;
a transmitted speech selection unit for selecting at least one of speech data of the recipient input from the speech input unit and the speech data of the other receiving board apparatus input from the speech multiplexing HUB apparatus as a speech to be transmitted to the inquirer, and outputting the speech data; and
a transferred speech selection unit for selecting at least one of the speech data regarding the speech of the inquirer and the speech data of the recipient input from the speech input unit as a speech to be sent to the speech multiplexing HUB apparatus, and outputting the speech data.

3. A system for receiving an inquiry by a speech according to claim 2, wherein the control unit controls the selection and outputting processing of the speech data of the received speech selection unit, the transmitted speech selection unit, and the transferred speech selection unit.

4. A system for receiving an inquiry by a speech according to claim 3, wherein when a response instruction to an incoming-call from the inquirer is input, the control unit of each receiving board apparatus controls the transferred speech selection unit to select the speech data regarding the speech of the inquirer and the speech data of the recipient input from the speech input unit and to output the speech data to the speech multiplexing HUB apparatus.

5. A system for receiving an inquiry by a speech according to claim 4, wherein when a monitoring instruction of a speech input to the other receiving board apparatus is input, the control unit of each receiving board apparatus controls the received speech selection unit to select the speech data of the other receiving board apparatus received from the speech multiplexing HUB apparatus and to output the speech data.

6. A system for receiving an inquiry by a speech according to claim 4, wherein:
when an interruption instruction to one side of telephone calling at the other receiving board apparatus is input, the control unit of each receiving board apparatus transmits a packet containing control data regarding the interruption to the control unit of the other receiving board apparatus via the LAN; and
based on the control data contained in the packet, the control unit of the other receiving board apparatus controls the received speech selection unit of the other receiving board apparatus to select the speech data regarding the speech of the inquirer and the speech data of the interrupting receiving board apparatus received from the speech multiplexing HUB apparatus and to output the speech data.

7. A system for receiving an inquiry by a speech according to claim 4, wherein:
when an interruption instruction to both sides of telephone calling at the other receiving board apparatus is input, the control unit of each receiving board apparatus transmits a packet containing control data regarding the interruption to the control unit of the other receiving board apparatus via the LAN; and
based on the control data contained in the packet, the control unit of the other receiving board apparatus controls the received speech selection unit of the other receiving board apparatus to select the speech data regarding the speech of the inquirer and the speech data of the interrupting receiving board apparatus received from the speech multiplexing HUB apparatus and to output the speech data, and the transmitted speech selection unit of the other receiving board apparatus to select the speech data input from the speech input unit and the speech data of the interrupting receiving board apparatus received from the speech multiplexing HUB apparatus and to control the speech data.

8. A system for receiving an inquiry by a speech according to claim 4, wherein:
the LAN is connected to a second LAN accommodating at least one second receiving board apparatus similar in configuration to the receiving board apparatus via a data line capable of transmitting packets;
the second receiving board apparatus receives data of the time-division multiplexed speech data of each receiving board apparatus transmitted from the speech multiplexing HUB apparatus via an analog line;
when an assistance request is input, the control unit of each receiving board apparatus transmits a packet containing data regarding the assistance request to the control unit of the second receiving board apparatus via the data line; and
when a response instruction to the assistance request is input, the control unit of the second receiving board apparatus controls the received speech selection unit of the second receiving board apparatus to select speech data of an assistance request source receiving board apparatus from the time-division multiplexed data and to output the speech data.

9. A system for receiving an inquiry by a speech according to claim 8, wherein:
when an interruption instruction to one side of telephone calling at the assisted receiving board apparatus is input, the control unit of the second receiving board apparatus transmits a packet containing control data regarding the interruption to the control unit of the assisted receiving board apparatus via the data line;
the speech mixing/distribution apparatus of the second receiving board apparatus outputs speech data of an interruption speech input to itself, the speech data of the interruption speech is input to the speech multiplexing HUB apparatus via the analog line, and the speech multiplexing HUB apparatus inputs the speech data of the interruption speech to the assisted receiving board apparatus; and
based on the control data contained in the packet, the control unit of the assisted receiving board apparatus controls the received speech selection unit of the assisted receiving board apparatus to select the speech data regarding the speech of the inquirer and the speech data of the interruption speech received from the speech multiplexing HUB apparatus and to output the speech data.

10. A system for receiving an inquiry by a speech according to claim 8, wherein:
when an interruption instruction to both sides of telephone calling at the assisted receiving board apparatus is input, the control unit of the second receiving board apparatus transmits a packet containing control data regarding the interruption to the control unit of the assisted receiving board apparatus via the data line;
the speech mixing/distribution apparatus of the second receiving board apparatus outputs speech data of an interruption speech input to itself, the speech data of the interruption speech is input to the speech multiplexing HUB apparatus via the analog line, and the speech multiplexing HUB apparatus inputs the speech data of the interruption speech to the assisted receiving board apparatus; and
based on the control data contained in the packet, the control unit of the assisted receiving board apparatus controls the received speech selection unit of the assisted receiving board apparatus to select the speech data regarding the speech of the inquirer and the speech data of the interruption speech received from the speech multiplexing HUB apparatus and to output the speech data, and the transmitted speech selection unit of the assisted receiving board apparatus to select the speech data input from the speech input unit and the speech data of the interruption speech received from the speech multiplexing HUB apparatus and to output the speech data.

11. A system for receiving an inquiry by a speech according to claim 4, wherein:
the LAN is connected to a second LAN accommodating at least one second receiving board apparatus similar in configuration to the receiving board apparatus via a data line capable of transmitting packets;
when an assistance request is input, the control unit of each receiving board apparatus transmits a packet containing data regarding the assistance request to the control unit of the second receiving board apparatus via the data line, and transfers a speech packet containing a monitoring target speech to the second receiving board apparatus which responds to the assistance request; and
when a response is made to the assistance request, the second receiving board apparatus outputs the monitoring target speech contained in the speech packet received from the assistance request source receiving board apparatus from the speech output unit included in the second receiving board apparatus.

12. A system for receiving an inquiry by a speech according to claim 11, wherein:
when an interruption instruction to one side of telephone calling at the assisted receiving board apparatus is input, the second receiving board apparatus transmits a packet containing control data regarding the interruption to the control unit of the assisted receiving board apparatus via the data line, and the speech packet containing the interruption speech input from the speech input unit included in the second receiving board apparatus to the control unit of the assisted receiving board apparatus via the data line; and
the assisted receiving board apparatus outputs the interruption speech contained in the speech packet from the speech output unit based on the control data regarding the interruption.

13. A system for receiving an inquiry by a speech according to claim 11, wherein:
when an interruption instruction to both sides of telephone calling at the assisted receiving board apparatus is input, the second receiving board apparatus transmits a packet containing control data regarding the interruption to the control unit of the assisted receiving board apparatus via the data line, and a speech packet containing an interruption speech input from the speech input unit included in the second receiving board apparatus to the assisted receiving board apparatus via the data line; and
the assisted receiving board apparatus outputs the interruption speech contained in the speech packet from the speech output unit and transmits the interruption speech to the inquirer based on the control data regarding the interruption.

14. A system for receiving an inquiry by a speech according to claim 11, wherein:
the speech mixing/distribution apparatus of the assisted receiving board apparatus further includes second transmitted speech selection unit capable of selecting speech data regarding a speech of the inquirer and speech data of the recipient and outputting the speech data; and
when the control unit of the assisted receiving board apparatus receives a response to the assistance request from the second receiving board apparatus, it controls the second transmitted speech selection unit to select the speech data of the inquirer and the speech data of the recipient and to output the speech data, and generates a speech packet containing the speech of the inquirer and/or the speech of the recipient received from the speech mixing/distribution apparatus and transmits the speech packet to the second receiving board apparatus.

15. A system for receiving an inquiry by a speech according to claim 12, wherein:
the speech mixing/distribution apparatus of the assisted receiving board apparatus further includes second received speech selection unit capable of selecting and outputting the speech data of the interruption speech when the speech data of the interruption speech contained in the speech packet from the second receiving board apparatus is input; and
when the control unit of the assisted receiving board apparatus receives the packet containing the control data regarding the interruption, it controls the second received speech selection unit to select the speech data of the interruption speech and to transmit the speech data to the speech output unit based on the control data regarding the interruption.

16. A system for receiving an inquiry by a speech according to claim 13, wherein:
the speech mixing/distribution apparatus of the assisted receiving board apparatus further includes second received speech selection unit capable of selecting and outputting the speech data of the interruption speech when the speech data of the interruption speech contained in the speech packet from the second receiving board apparatus is input; and
when the control unit of the assisted receiving board apparatus receives the packet containing the control data regarding the interruption, it controls the second received speech selection unit to select the speech data of the interruption speech and to output the speech data to the speech output unit and the transmitted speech selection unit to select and output the speech data of the interruption speech input to itself based on the control data regarding the interruption.
